(19) United States
(12) Patent Application Publication
(10) Pub. No.: US 2026/0246836 A1
(43) Pub. Date: Aug. 20, 2026

(54) DISTRIBUTED SYSTEM IN SOFTWARE DEFINED VEHICLES

(71) Applicant: Google LLC, Mountain View, CA (US)

(72) Inventors: Julius D'Souza, San Francisco, CA (US); Ashutosh Agarwal, Bellevue, WA (US)

(21) Appl. No.: 19/055,284

(22) Filed: Feb. 17, 2025

(51) Int. Cl. H04L 67/12; G06F 9/455; H04L 9/40

(52) U.S. Cl. CPC H04L 67/12; G06F 9/45558; H04L 63/08

(57) ABSTRACT

A software-defined vehicle (SDV) includes and connects to multiple independent SDV systems and independent external non-SDV systems that may interact with each other and provide execution environments for various services. The independent systems may be members of a leaderless group of trusted independent systems that provides a consistent record of service identities, service registrations, and runtime interfaces across the distributed system. Each member of the leaderless group of trusted independent systems may adhere to group membership protocols and may be a sole source of truth for the services it provides. The independent systems may be orchestrated using workflows specified by directed acyclic graphs of runtime interfaces and methods, and may be dynamically executed via service discovery. Communication between services may be secured based on a mapping between operating system process identities and SDV service identities that are created and stored using a network tap and packet filter system program.

### BACKGROUND

The automotive industry is rapidly evolving towards software-defined vehicles (SDVs), where numerous interconnected electronic control units (ECUs) and software components govern various vehicle functions. However, there are many challenges associated with service security, management, and communication across an SDV system, as different services may be hosted on multiple gateways (infotainment, cloud, etc.) have varying architectures, and may have integrations operating at different abstraction levels (e.g., user-facing applications versus cloud backend services). The complexity of these interconnected systems, coupled with the need for real-time responsiveness and safety-critical operation, can lead to security issues, communication bottlenecks, data inconsistencies, and potential failures that impact vehicle performance, safety and user experience.

### SUMMARY

In general, techniques of this disclosure are directed to techniques for executing a plurality of trusted independent systems in a software-defined vehicle (SDV) operating system (OS). An SDV may include and/or be in communication with a plurality of distributed software services that may interact with each other. Each service (e.g., a service executed by servers, clients, etc.) may be provided by a service unit, or a fragment of code included in a service bundle (e.g., a software package) that implements a unit type (e.g., an interface) from a plurality of unit types. In general, a service bundle may be executed by an independent system from a plurality of independent systems (e.g., virtual machines (VMs), remote entities, etc.). In general, the SDV OS may authenticate and attest one or more independent systems from the plurality of independent systems, in which the authenticated and attested independent systems may be admitted to a group of trusted independent systems that is managed by a communications layer. For example, the communications layer may implement a group membership protocol. In some examples, the group of trusted independent systems adheres to a shared state Byzantine agreement protocol, and communication within the group of trusted independent systems may be based on a shared secret key. That is, the group of trusted independent systems may reach consensus on a shared state or decision, even when faulty or malicious group members are present. To do so, each trusted independent system may be a single source of truth for the one or more service bundles that it defines.

In general, the leaderless group of trusted independent systems may monitor a plurality of workflows executed within the SDV. For example, after initializing the group of trusted independent systems, the SDV OS may execute a workflow from the plurality of workflows. Each workflow may be specified by a directed acyclic graph (DAG) that includes a plurality of nodes and a plurality of edges. Each node may be associated with a respective unit type from the plurality of unit types. As such, the workflow may not have to specify the exact independent system for each node that is to be executed, and instead may simply specify a standard unit type name for each node. As an example, the workflow may specify a first unit type for a first node. While executing the workflow, the SDV OS may provide, to the communications layer, and based on the first unit type associated with the first node, a query, in which the query includes a request to discover at least one available implementation of the first unit type. As such, the database managed by the communications layer may be queried to determine whether one or more trusted independent systems that implement the first unit type are available. Responsive to determining one or more trusted independent systems that implement the first unit type are available, the SDV OS may select (e.g., based on one or more resource permissions specified by the workflow) a particular trusted independent system that implements the first unit type and is available. While still executing the workflow, the SDV OS may then execute the selected trusted independent system. Furthermore, communication between services provided by executed trusted independent systems may be secured based on a mapping between operating system process identities and SDV service identities that are created and stored using a network tap and packet filter system program.

In one example, this disclosure describes a method that includes initializing, by an operating system of a vehicle, a plurality of independent systems, wherein each independent system from the plurality of independent systems implements a unit type from a plurality of unit types, and executing, by the operating system, a workflow from a plurality of workflows, wherein the workflow forms a graph that includes a plurality of nodes, and wherein each node from the plurality of nodes is associated with a respective unit type from the plurality of unit types. The method further includes, while executing the workflow, providing, by the operating system, and to a communications layer, and based on a first unit type from the plurality of unit types, a query, wherein the first unit type is associated with a first node from the plurality of nodes, and wherein the query includes a request to discover at least one available implementation of the first unit type. The method further includes, while executing the workflow, executing, by the operating system, and based on the at least one available implementation of the first unit type, a selected independent system from the plurality of independent systems, wherein the selected independent system implements the first unit type.

In another example, this disclosure describes a computing system including one or more processors and one or more storage devices that store instructions. The instructions, when executed by the one or more processors, cause the one or more processors to initialize a plurality of independent systems, wherein each independent system from the plurality of independent systems implements a unit type from a plurality of unit types, and execute a workflow from a plurality of workflows, wherein the workflow forms a graph that includes a plurality of nodes, and wherein each node from the plurality of nodes is associated with a respective unit type from the plurality of unit types. The instructions further cause the one or more processors to, while executing the workflow, provide, to a communications layer, and based on a first unit type from the plurality of unit types, a query, wherein the first unit type is associated with a first node from the plurality of nodes, and wherein the query includes a request to discover at least one available implementation of the first unit type. The instructions further cause the one or more processors to, while executing the workflow, execute, based on the at least one available implementation of the first unit type, a selected independent system from the plurality of independent systems, wherein the selected independent system implements the first unit type.

In yet another example, this disclosure describes a non-transitory computer-readable storage medium encoded with instructions. The instructions, when executed by one or more processors, cause the one or more processors to initialize a plurality of independent systems, wherein each independent system from the plurality of independent systems implements a unit type from a plurality of unit types, and execute a workflow from a plurality of workflows, wherein the workflow forms a graph, and wherein each node from the plurality of nodes is associated with a respective unit type from the plurality of unit types. The instructions further cause the one or more processors to, while executing the workflow, provide, to a communications layer, and based on a first unit type from the plurality of unit types, a query, wherein the first unit type is associated with a first node from the plurality of nodes, and wherein the query includes a request to discover at least one available implementation of the first unit type. The instructions further cause the one or more processors to, while executing the workflow, execute, based on the at least one available implementation of the first unit type, a selected independent system from the plurality of independent systems, wherein the selected independent system implements the first unit type.

In yet another example, this disclosure describes a computer program product for service verification, the computer program product comprising instructions. The instructions, when executed by one or more processors, cause the one or more processors to initialize a plurality of independent systems, wherein each independent system from the plurality of independent systems implements a unit type from a plurality of unit types, and execute a workflow from a plurality of workflows, wherein the workflow forms a graph that includes a plurality of nodes, and wherein each node from the plurality of nodes is associated with a respective unit type from the plurality of unit types. The instructions further cause the one or more processors to, while executing the workflow, provide, to a communications layer, and based on a first unit type from the plurality of unit types, a query, wherein the first unit type is associated with a first node from the plurality of nodes, and wherein the query includes a request to discover at least one available implementation of the first unit type. The instructions further cause the one or more processors to, while executing the workflow, execute, based on the at least one available implementation of the first unit type, a selected independent system from the plurality of independent systems, wherein the selected independent system implements the first unit type.

In yet another example, this disclosure describes a method that includes executing, by an operating system of a vehicle, an instance of a first trusted independent system from a plurality of trusted independent systems, wherein the instance of the first trusted independent system includes a communication broker, wherein the communication broker manages communication between the operating system and one or more remote entities, wherein the instance of the first trusted independent system provides one or more application programming interfaces, and wherein one or more implementations of one or more unit types by the one or more remote entities are discovered via the one or more application programming interfaces. The method further includes executing, by the operating system, an instance of a second trusted independent system from a plurality of trusted independent systems, wherein the instance of the second trusted independent system implements a first unit type from the one or more unit types. The method further includes, while executing the instance of the second trusted independent system, providing, by the operating system, and via the one or more application programming interfaces, a query, wherein the query includes a request to discover at least one available implementation of the first unit type by the one or more remote entities. The method further includes establishing, by the operating system, and using the communication broker, and based on an available implementation of the first unit type by a remote entity from the one or more remote entities, a connection between the instance of the second trusted independent system and the remote entity. The method further includes executing, by the operating system, the instance of the second trusted independent system based on the implementation of the first unit type by the remote entity.

In yet another example, this disclosure describes a computing system including one or more processors and one or more storage devices that store instructions. The instructions, when executed by the one or more processors, cause the one or more processors to execute an instance of a first trusted independent system from a plurality of trusted independent systems, wherein the instance of the first trusted independent system includes a communication broker, wherein the communication broker manages communication between the operating system and one or more remote entities, wherein the instance of the first trusted independent system provides one or more application programming interfaces, and wherein one or more implementations of one or more unit types by the one or more remote entities are discovered via the one or more application programming interfaces. The instructions further cause the one or more processors to execute an instance of a second trusted independent system from a plurality of trusted independent systems, wherein the instance of the second trusted independent system implements a first unit type from the one or more unit types. The instructions further cause the one or more processors to, while executing the instance of the second trusted independent system, provide, via the one or more application programming interfaces, a query, wherein the query includes a request to discover at least one available implementation of the first unit type by the one or more remote entities, and establish, using the communication broker, and based on an available implementation of the first unit type by a remote entity from the one or more remote entities, a connection between the instance of the second trusted independent system and the remote entity. The instructions further cause the one or more processors to execute the instance of the second trusted independent system based on the implementation of the first unit type by the remote entity.

In yet another example, this disclosure describes a non-transitory computer-readable storage medium encoded with instructions. The instructions, when executed by one or more processors, cause the one or more processors to. The instructions further cause the one or more processors to execute an instance of a first trusted independent system from a plurality of trusted independent systems, wherein the instance of the first trusted independent system includes a communication broker, wherein the communication broker manages communication between the operating system and one or more remote entities, wherein the instance of the first trusted independent system provides one or more application programming interfaces, and wherein one or more implementations of one or more unit types by the one or more remote entities are discovered via the one or more application programming interfaces. The instructions further cause the one or more processors to execute an instance of a second trusted independent system from a plurality of trusted independent systems, wherein the instance of the second trusted independent system implements a first unit type from the one or more unit types. The instructions further cause the one or more processors to, while executing the instance of the second trusted independent system, provide, via the one or more application programming interfaces, a query, wherein the query includes a request to discover at least one available implementation of the first unit type by the one or more remote entities, and establish, using the communication broker, and based on an available implementation of the first unit type by a remote entity from the one or more remote entities, a connection between the instance of the second trusted independent system and the remote entity. The instructions further cause the one or more processors to execute the instance of the second trusted independent system based on the implementation of the first unit type by the remote entity.

In yet another example, this disclosure describes a computer program product for service verification, the computer program product comprising instructions. The instructions, when executed by one or more processors, cause the one or more processors to execute an instance of a first trusted independent system from a plurality of trusted independent systems, wherein the instance of the first trusted independent system includes a communication broker, wherein the communication broker manages communication between the operating system and one or more remote entities, wherein the instance of the first trusted independent system provides one or more application programming interfaces, and wherein one or more implementations of one or more unit types by the one or more remote entities are discovered via the one or more application programming interfaces. The instructions further cause the one or more processors to execute an instance of a second trusted independent system from a plurality of trusted independent systems, wherein the instance of the second trusted independent system implements a first unit type from the one or more unit types. The instructions further cause the one or more processors to, while executing the instance of the second trusted independent system, provide, via the one or more application programming interfaces, a query, wherein the query includes a request to discover at least one available implementation of the first unit type by the one or more remote entities, and establish, using the communication broker, and based on an available implementation of the first unit type by a remote entity from the one or more remote entities, a connection between the instance of the second trusted independent system and the remote entity. The instructions further cause the one or more processors to execute the instance of the second trusted independent system based on the implementation of the first unit type by the remote entity.

In yet another example, this disclosure describes a method that includes authenticating, by an operating system of a vehicle, and using a communications layer, one or more independent systems from a plurality of independent systems, and attesting, by the operating system and using the communications layer, the one or more independent systems from the plurality of independent systems. The method further includes, responsive to authenticating and attesting the one or more independent systems from the plurality of independent systems, admitting, by the operating system and using the communications layer, the one or more independent systems to a group, wherein the group is a plurality of trusted independent systems. The method further includes initializing, by the operating system, the plurality of trusted independent systems, wherein each trusted independent system from the plurality of trusted independent systems defines one or more service units and is a single source of truth for the one or more service units, and wherein each of the one or more service units implements a unit type from a plurality of unit types. The method further includes executing, by the operating system, and based on at least one available implementation of a first unit type from the plurality of unit types, a selected trusted independent system from the plurality of trusted independent systems, wherein the selected trusted independent system implements the first unit type.

In yet another example, this disclosure describes a computing system including one or more processors and one or more storage devices that store instructions. The instructions, when executed by the one or more processors, cause the one or more processors to authenticate, using a communications layer, one or more independent systems from a plurality of independent systems, and attest, using the communications layer, the one or more independent systems from the plurality of independent systems. The instructions further the one or more processors to, responsive to authenticating and attesting the one or more independent systems from the plurality of independent systems, admit, using the communications layer, the one or more independent systems to a group, wherein the group is a plurality of trusted independent systems. The instructions further the one or more processors to initialize the plurality of trusted independent systems, wherein each trusted independent system from the plurality of trusted independent systems defines one or more service units and is a single source of truth for the one or more service units, and wherein each of the one or more service units implements a unit type from a plurality of unit types. The instructions further the one or more processors to execute, based on at least one available implementation of a first unit type from the plurality of unit types, a selected trusted independent system from the plurality of trusted independent systems, wherein the selected trusted independent system implements the first unit type.

In yet another example, this disclosure describes a non-transitory computer-readable storage medium encoded with instructions. The instructions, when executed by one or more processors, cause the one or more processors to authenticate, using a communications layer, one or more independent systems from a plurality of independent systems, and attest, using the communications layer, the one or more independent systems from the plurality of independent systems. The instructions further the one or more processors to, responsive to authenticating and attesting the one or more independent systems from the plurality of independent systems, admit, using the communications layer, the one or more independent systems to a group, wherein the group is a plurality of trusted independent systems. The instructions further the one or more processors to initialize the plurality of trusted independent systems, wherein each trusted independent system from the plurality of trusted independent systems defines one or more service units and is a single source of truth for the one or more service units, and wherein each of the one or more service units implements a unit type from a plurality of unit types. The instructions further the one or more processors to execute, based on at least one available implementation of a first unit type from the plurality of unit types, a selected trusted independent system from the plurality of trusted independent systems, wherein the selected trusted independent system implements the first unit type.

In yet another example, this disclosure describes a computer program product for service verification, the computer program product comprising instructions. The instructions, when executed by one or more processors, cause the one or more processors to authenticate, using a communications layer, one or more independent systems from a plurality of independent systems, and attest, using the communications layer, the one or more independent systems from the plurality of independent systems. The instructions further the one or more processors to, responsive to authenticating and attesting the one or more independent systems from the plurality of independent systems, admit, using the communications layer, the one or more independent systems to a group, wherein the group is a plurality of trusted independent systems. The instructions further the one or more processors to initialize the plurality of trusted independent systems, wherein each trusted independent system from the plurality of trusted independent systems defines one or more service units and is a single source of truth for the one or more service units, and wherein each of the one or more service units implements a unit type from a plurality of unit types. The instructions further the one or more processors to execute, based on at least one available implementation of a first unit type from the plurality of unit types, a selected trusted independent system from the plurality of trusted independent systems, wherein the selected trusted independent system implements the first unit type.

In yet another example, this disclosure describes a method that includes executing, by an operating system of a vehicle, and using a service manager, a binary program to initialize a network tap and packet filter system program within a kernel of a guest operating system managed by the operating system, wherein the network tap and packet filter system program monitors a respective lifecycle of one or more instances of one or more service bundles. The method further includes initializing, by the operating system, and using the service manager, the one or more instances of the one or more service bundles. To initialize the one or more instances of the one or more service bundles, the method further includes obtaining, by the operating system and from a registry, and based on a respective unique service identifier, a respective service name associated with each of the one or more instances of the one or more service bundles, and creating, by the operating system and using the network tap and packet filter system program, a respective public-private key pair for each of the one or more instances of the one or more service bundles. To initialize the one or more instances of the one or more service bundles, the method further includes creating, by the operating system and using the network tap and packet filter system program, a respective service identity object for each of the one or more instances of the one or more service bundles, wherein the respective service identity object includes a respective unique process identifier, the respective service name, and a public key from the respective public-private key pair, and storing, by the operating system and using the network tap and packet filter system program, each respective service identity object in a kernel map managed by the network tap and packet filter system program.

In yet another example, this disclosure describes a computing system including one or more processors and one or more storage devices that store instructions. The instructions, when executed by the one or more processors, cause the one or more processors to execute, using a service manager, a binary program to initialize a network tap and packet filter system program within a kernel of a guest operating system managed by the operating system, wherein the network tap and packet filter system program monitors a respective lifecycle of one or more instances of one or more service bundles. The instructions further cause the one or more processors to initialize, using the service manager, the one or more instances of the one or more service bundles. To initialize the one or more instances of the one or more service bundles, the instructions further cause the one or more processors to obtain, from a registry, and based on a respective unique service identifier, a respective service name associated with each of the one or more instances of the one or more service bundles, and create, using the network tap and packet filter system program, a respective public-private key pair for each of the one or more instances of the one or more service bundles. To initialize the one or more instances of the one or more service bundles, the instructions further cause the one or more processors to create, using the network tap and packet filter system program, a respective service identity object for each of the one or more instances of the one or more service bundles, wherein the respective service identity object includes a respective unique process identifier, the respective service name, and a public key from the respective public-private key pair, and store, using the network tap and packet filter system program, each respective service identity object in a kernel map managed by the network tap and packet filter system program.

In yet another example, this disclosure describes a non-transitory computer-readable storage medium encoded with instructions. The instructions, when executed by one or more processors, cause the one or more processors to execute, using a service manager, a binary program to initialize a network tap and packet filter system program within a kernel of a guest operating system managed by the operating system, wherein the network tap and packet filter system program monitors a respective lifecycle of one or more instances of one or more service bundles. The instructions further cause the one or more processors to initialize, using the service manager, the one or more instances of the one or more service bundles. To initialize the one or more instances of the one or more service bundles, the instructions further cause the one or more processors to obtain, from a registry, and based on a respective unique service identifier, a respective service name associated with each of the one or more instances of the one or more service bundles, and create, using the network tap and packet filter system program, a respective public-private key pair for each of the one or more instances of the one or more service bundles. To initialize the one or more instances of the one or more service bundles, the instructions further cause the one or more processors to create, using the network tap and packet filter system program, a respective service identity object for each of the one or more instances of the one or more service bundles, wherein the respective service identity object includes a respective unique process identifier, the respective service name, and a public key from the respective public-private key pair, and store, using the network tap and packet filter system program, each respective service identity object in a kernel map managed by the network tap and packet filter system program.

In yet another example, this disclosure describes a computer program product for service verification, the computer program product comprising instructions. The instructions, when executed by one or more processors, cause the one or more processors to execute, using a service manager, a binary program to initialize a network tap and packet filter system program within a kernel of a guest operating system managed by the operating system, wherein the network tap and packet filter system program monitors a respective lifecycle of one or more instances of one or more service bundles. The instructions further cause the one or more processors to initialize, using the service manager, the one or more instances of the one or more service bundles. To initialize the one or more instances of the one or more service bundles, the instructions further cause the one or more processors to obtain, from a registry, and based on a respective unique service identifier, a respective service name associated with each of the one or more instances of the one or more service bundles, and create, using the network tap and packet filter system program, a respective public-private key pair for each of the one or more instances of the one or more service bundles. To initialize the one or more instances of the one or more service bundles, the instructions further cause the one or more processors to create, using the network tap and packet filter system program, a respective service identity object for each of the one or more instances of the one or more service bundles, wherein the respective service identity object includes a respective unique process identifier, the respective service name, and a public key from the respective public-private key pair, and store, using the network tap and packet filter system program, each respective service identity object in a kernel map managed by the network tap and packet filter system program.

The details of one or more examples of the disclosure are set forth in the accompanying drawings and the description below. Other features, objects, and advantages will be apparent from the description and drawings, and from the claims.

### BRIEF DESCRIPTION OF DRAWINGS

FIG. 1 illustrates an example computing system including an operating system that executes a plurality of trusted independent systems, in accordance with one or more techniques of this disclosure.

FIG. 2 illustrates another example computing system including an operating system that executes a plurality of trusted independent systems, in accordance with one or more techniques of this disclosure.

FIG. 3 illustrates another example computing system including an operating system that executes a plurality of trusted independent systems, in accordance with one or more techniques of this disclosure.

FIG. 4 is a flow chart illustrating example operations of an operating system that creates context-based service identities for communication between services, in accordance with one or more techniques of this disclosure.

FIG. 5 is a flow chart illustrating example operations of an operating system that creates context-based service identities for communication between services, in accordance with one or more techniques of this disclosure.

FIG. 6 is a flow chart illustrating example operations of an operating system that creates context-based service identities for communication between services, in accordance with one or more techniques of this disclosure.

FIG. 7 is a flow chart illustrating example operations of an operating system that creates context-based service identities for communication between services, in accordance with one or more techniques of this disclosure.

### DETAILED DESCRIPTION

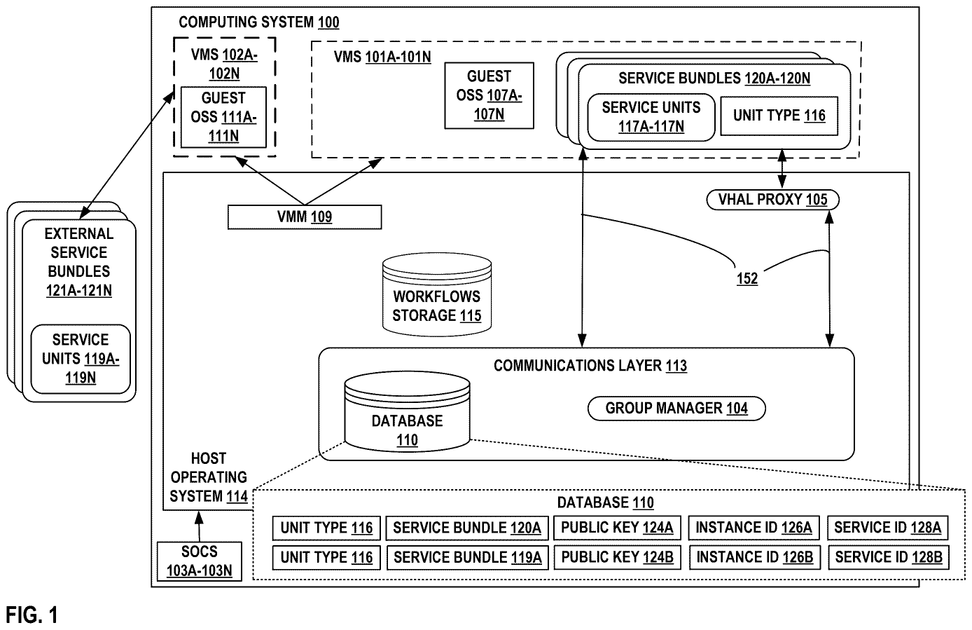

FIG. 1 illustrates an example computing system including an operating system that executes a plurality of trusted independent systems, in accordance with one or more techniques of this disclosure. Computing system 100 may be a vehicle computing system. Computing system 100 may be a computing system for a software defined vehicle (SDV). Computing system 100 may generally refer to a computing system included in automobiles such as cars, trucks, and vans, for the sake of simplicity and clarity within this disclosure. However, the techniques described herein may be applied to a wide variety of vehicle types, including motorcycles, recreational vehicles, farm vehicles and farm implements, aircraft, watercraft, and the like.

As shown in FIG. 1, computing system 100 may include virtual machines (“VMs”) 101A-101N (collectively referred to herein as “VMs 101”), VMs 102A-102N (collectively referred to herein as “VMs 102”), and systems on chips (“SOCS”) 103A-103N (collectively referred to herein as “SOCs 103”). Throughout this disclosure, although sets of VMs 101, VMs 102, SOCs 103, and other components are described as including A-N example components, there is no explicit or implicit requirement that there needs to be the same number of VMs, SOCs, or other example components, and there may be more or fewer example components in a particular set of components than another set of components. For example, in some examples, computing system 100 may include one SOC 103A that OS 114 is executed on, multiple VMs 101, a single VM 102, and service bundles 120A-120N, in which VMs 101 may provide an execution environment for one or more of service bundles 120A-120N, and VM 102 may provide an execution environment for one or more of external service bundles 121A-121N. In some examples, service bundles 120A-120N may be executed on host OS 114, e.g., service bundles 120A-120N may be executed within a single independent system.

In the example of FIG. 1, vehicle host operating system (OS) 114 may be an example software-defined vehicle (SDV) operating system that may include or execute multiple service bundles, such as service bundles 120A-120N. A “service bundle” may be considered an application, software package, bundle of code, or the like that provides a service (e.g., a service executed by servers, clients, etc.). In some examples, each service bundle may define a “service unit,” such as service units 117A-117N and service units 119A-119N, which may each be considered a fragment of code that implements a “unit type” (e.g., an interface). For example, a service unit may be one or more lines of code that define how the method(s) declared by the interface are actually performed. In some examples, a service bundle may define more than one service unit and/or provide more than one service.

As such, in general, computing system 100 may include and/or be in communication with a plurality of distributed software services that may interact with each other in various ways. Service bundles 120A-120N and external service bundles 121A-121N may be considered part of a Service-Oriented Architecture (SOA) in a distributed system. For example, the services provided by service bundles 120A-120N may be hosted on a plurality of independent systems included within an SDV, such as electronic control units (ECUs), or virtual machines (VMs) 101A-101N. The services provided by external service bundles 121A-121N may be hosted on a plurality of independent systems not included within the core SDV system (e.g., external non-SDV systems), such as In-Vehicle Infotainment (IVI) systems, cloud services, user computing devices, etc. Thus, host OS 114 may provide solutions for updates, stable integration, and communication of SDV components with services that may or may not be hosted on different independent systems and may or may not be included within the SDV.

In general, each independent system from the plurality of independent systems may declare and/or implement a unit type from a plurality of unit types. A “unit type,” as used throughout this disclosure, may be considered a data contract that declares the structure, behavior, and/or expectations for how services, components, or classes interact and exchange information across computing system 100. That is, in some examples, a service bundle and/or service unit may declare a unit type without providing any implementation details. A service bundle and/or service unit may implement a unit type declared by another service bundle and/or service unit, in which the service bundle and/or service unit that implements the unit type may provide the implementation details.

For example, in some examples, a unit type may be a type declaration that represents an interface, in which the unit type may declare one or more methods that a service bundle and/or service unit may implement (e.g., the service bundle and/or service unit may define how the methods declared by the interface are actually performed). As an example, a unit type may be an interface type, and a service unit may be a Remote Procedure Call server or a Remote Procedure Call client that implements the interface type. A unit type may define runtime interface specifications and serve as a basis for managing permissions.

In some examples, a unit type may be a type declaration that represents a message, in which the unit type declares the structure and format of data that a service bundle and/or service unit may send or receive. As an example, a unit type may be a message type, and a service unit may be a publisher unit or a subscriber unit that implements the message type.

In some examples, a service unit may only implement one unit type. In some examples, if a service bundle defines multiple service units, the service bundle may implement multiple different unit types. In some other examples, a service bundle may only implement one unit type (i.e., each service unit defined by a particular service bundle may implement the same unit type). In some examples, unit types may not represent or include any business logic or code and may only include semantic information. A service unit, or implementation of a unit type, may include business logic or code that implements the semantic information expressed in the unit type.

Although FIG. 1 shows computing system 100 including multiple VMs, computing system 100 may additionally or alternatively include one or more components such as automotive head units, ECUs, engine control modules (ECM), control systems, servers, computing devices, full authority digital engine controls (FADECs), automotive computing modules, and the like. In some examples, the components of computing system 100 may be interconnected to form a computing network of a vehicle.

Host OS 114 may utilize processing circuitry including logic circuitry that responds to and processes basic instructions that, when executed, cause a computing system to perform operations. For example, host OS 114 may be executed on a centralized computing system module such as a System On a Chip or “SOC” type processing circuitry type device or a collection of interconnected components, such as a central processing unit (CPU) for executing operations and computer instructions, memory for storing computer instructions, Input/Output (I/O) components, communication busses, signal processing components, etc. As shown in the example of FIG. 1, host OS 114 may be executed on one of System On a Chip(s) (SOCs) 103A-103N. In some examples, host OS 114 may be executed on a single SOC 103A and execute virtual machine monitor (VMM) 109. VMM 109 may be a program, plugin, hypervisor, or other type of process. VMM 109 may manage the execution of VMs 101 and VMs 102, in which each of VMs 101 may be executed on one of guest OSs 107A-107N, and each of VMs 102 may be executed on one of guest OSs 111A-111N (e.g., a VM may be the virtual hardware that a guest OS runs on). In other examples, each SOC from SOCs 103A-103N may execute an OS that executes a single VM from VMs 101, VMs 102, or another component included in computing system 100. In some examples, each SOC from SOCs 103A-103N may control different functions (infotainment, telematics, drive control, etc.) of an SDV. In some examples, computing system 100 may include a plurality of independent systems that include one or more independent VMs executing on independent SOCs and/or one or more independent ECUs. For example, VM101A and VM101B may be considered two different independent systems.

Computing system 100 may execute one or more of VMs 101, VMs 102, pods, or containerized workloads, among other types of virtualized computing environments. In traditional vehicles, distinct ECUs may be dedicated to specific functions like engine control, braking, infotainment, etc., in which each ECU may operate independently, and thus may cause redundancy in hardware, increased complexity, and challenges in updateability and security. In an SDV that includes computing system 100, however, the integration of VMs 101 and VMs 102 may help to consolidate ECUs, as the SDV may use more powerful computing platforms that can host VMs 101 and VMs 102. One or more of VMs 101 and VMs 102 may function as a virtual ECU, which may help to reduce physical hardware needed, provide isolation of systems, and allow for greater flexibility in deploying and updating software. Furthermore, the use of VMs 101 and VMs 102 in an SDV may improve resource allocation, provide easier software development and testing environments, and result in safer, more efficient, and more adaptable vehicles.

In general, computing system 100 may execute one or more of VMs 101 to provide an execution environment for services of computing system 100, and may execute one or more of VMs 102 to provide an execution environment for services external to computing system 100. Each VM from VMs 101 may provide an execution environment for one or more processes such as an OS kernel of a guest OS from guests OSs 107A-107N and one or more service bundles from service bundles 120A-120N (collectively referred to herein as “service bundles 120”). In some examples, each service bundle from service bundles 120 may uniquely map to a single OS process, e.g., each service bundle may uniquely map to a single guest OS process on a given VM.

In general, VMs 102 may be specialized VMs that are reserved for connecting to remote entities, such as entities that include and/or execute external service bundles 121A-121N. A remote entity may be any external system that hosts services that computing system 100 may need or want to interact with, and are accessible via a gateway and/or communication broker. Example remote entities may include IVI systems, cloud services, user devices, services based on the Automotive Open System Architecture (AUTOSAR) standard, etc. Each of external service bundles 121A-121N may provide one or more services that are running outside of the core SDV system itself, but may integrate and/or communicate with SDV components. In general, external service bundles 121A-121N may be hosted and run on different external independent systems (not shown in FIG. 1), e.g., cloud-hosted VMs, edge devices (edge computing nodes such as charge stations, roadside units, etc.), external SOCs (ADAS controllers, SOCs in connected IoT devices, etc.), external OSs (AUTOSAR platforms, user computing device OSs, etc.), cloud services, and the like.

Thus, external service bundles 121A-121N may need to be discoverable by components included in computing system 100. Each of VMs 102 may be considered a “gateway,” e.g., a specialized VM within the SDV system that enables communication between the SDV and remote entities. In some examples, VMs 102 may be or only include a single VM designated for communication with remote entities. That is, computing system 100 may include one gateway or multiple gateways. In some examples, gateway components of the same type (e.g. infotainment units, cloud instances) may be bundled together as gateway groups that are assigned to a particular VM from VMs 102.

In some examples, one or more of VMs 102 may implement a communication stack, e.g., a set of protocols and standards used for communication. In general, one or more of VMs 102 may act as an intermediary that simplifies and manages communication between remote entities and the SDV system, e.g., VMs 102 may provide a secure, controlled, and standardized interface for external systems. In some examples, one or more of VMs 102 may include a specialized “broker” to handle coordination tasks. A “broker” may be a singleton process (e.g., a single instance that runs across the system) within a Gateway, and may be responsible for understanding the communication requirements and protocols of remote entities. In some examples, a broker may translate and convert connections and service-related information into formats compatible with the SDV system. Thus, in general, VMs 102 may ensure seamless integration of external service bundles 121A-121N with computing system 100 by abstracting complexities such as differing communication protocols. In this way, VMs 102 may cause remote entities to appear “native” to the SDV system.

In general, computing system 100 may include one or more communication channels 152 which may be one or more in-vehicle networks or vehicular communication systems that provide communication paths between various vehicle service bundles, units, nodes, modules, etc. within computing system 100 and/or external to computing system 100. In some examples, a communication channel 152 may be exclusive to one specific vehicle service. In some examples, a communication channel 152 may be shared amongst multiple vehicle services. In some examples, host OS 114 may manage VHAL proxy 105 that may be configured as a collection of executable instructions stored within memory or other persistent storage, that, when executed, interfaces with various components of computing system 100 and/or external to computing system 100.

Database system 110 may provide an organized collection of structured information, or data, stored electronically within memory and/or persisted within a datastore. Database system 110 may implement a database management system (DBMS) that manages stored data, relationships, database queries, updates, conflicts, etc. Collectively, the data stored within a database system, the DBMS, along with associated applications may be referred to as a “database system,” which is often shortened to simply a “database.” Database system 110 may be a structured query language (SQL) type database system implementation that arranges data using rows and columns in a series of tables having defined relationships between them. Data stored in database system 110 may be accessed, managed, modified, updated, controlled, and/or organized using a structured query language (SQL) for writing and querying data. As an example, communication layer 113 may query database system 110 to receive various information, such as a set of implementations of one or more unit types by one or more independent systems. For example, while guest OS 107A is executing VM 101A to execute service bundle 120A (i.e., at runtime), communication layer 113 may fetch, from database system 110, a set of implementations of one or more unit types by one or more service units 117B-117N and/or one or more external service units 119A-119N. While still executing service bundle 120A, guest OS 107A may load the set of implementations to provide the functionality of service bundle 120A.

To ensure greater security within the SDV system, however, each VM from VMs 101 and VMs 102 may be required to complete authentication and attestation before being integrated into the SDV system and executed to provide various services. In general, the techniques described herein may provide solutions for advancing the development of zonal electronic architectures in vehicles, and may help address challenges in ensuring consistent and dependable computing performance for services, even when the underlying hardware is not specifically designed for high-end, specialized tasks (but is still of sufficient quality to meet automotive standards). Typically, such challenges are seen in backend servers, but SDVs may operate under soft real-time conditions with limited resources that are distributed across multiple computing units within the vehicle's network. The SDV environment may be very different from server-based distributed systems, where computing resources are more abundant, real-time constraints are rare, and communication occurs over wide-area networks. Furthermore, while general-purpose distributed system algorithms exist, they may not be designed for critical operations within a vehicle's local network, and using these preexisting algorithms could lead to performance issues and failing to meet the unique requirements of automotive systems. Lastly, edge computing processes data closer to where the data is collected, and SDVs represent one of the most advanced examples of edge computing available to consumers. Modern vehicles may combine powerful processors with numerous sensors, thus creating a unique environment that does not resemble typical server workloads found in cloud systems. As such, in accordance with the techniques of this disclosure, computing system 100 may execute a plurality of independent systems, e.g., one or more of VMs 101 and VMs 102, each of which may be a trusted member of a leaderless group. The leaderless group may be designed to provide a reliable distributed systems backbone for the SDV as a subsystem, in which the subsystem may manage a system shared state while being tolerant to individual instance failure, e.g., in a system crash or forced reboot operation.

Specifically, in the example of FIG. 1, one or more of VMs 101 and VMs 102 may be considered a trusted independent system that is a member of the leaderless group, which may be managed by communications layer 113. In general, the “leaderless group of trusted independent systems” may refer to a group of independent systems (e.g., one or more trusted VMs from VMs 101 and VMs 102) that are running in multiple OS instances and have completed authentication and attestation (and thus can be considered “trusted”).

As shown in the example of FIG. 1, communications layer 113 may include group manager 104, which may implement one or more protocols that members of the trusted group of independent systems must adhere to, such as a group membership protocol. Throughout this disclosure, “independent system,” “VM,” “entity,” and/or “node” may be used interchangeably. In some examples, a “node” may be considered an OS instance. In some examples, a “node” may be considered an independent system (e.g., VM 101A) that is running in a particular OS instance. To form the group of trusted independent systems, VMs 101 and VMs 102 may authenticate each other. In general, an independent system may only gain membership to the group of trusted independent systems by authenticating and attesting to the group. In general, authentication may pertain to verification of an entity's identity, and attestation may pertain to verification of the trustworthiness and integrity of an entity (e.g., a VM's state or configuration). In some examples, membership may only be granted to known entities, e.g., independent systems that are predefined as required members. For example, in some examples, to manage the group, group manager 104 may use a structured configuration file or metadata document that governs various aspects of host OS 114 and acts as a central repository for defining and managing components, services, permissions, and interactions within host OS 114. In some examples, the structured configuration file or metadata document may include all of the public keys that can identify potential group members (e.g., VMs), all service bundle namespaces that may be registered on a particular OS instance, etc. In some examples, only the independent systems declared in the structured configuration file or metadata document may be authorized to join the group of trusted independent systems. In some examples, identifier values may be used by group manager 104 to authenticate independent systems. In some examples, an IPv4 address and/or an IPv6 address may be used by group manager 104 to verify independent systems. In some examples, group membership may be cryptographically provable. In some examples, group manager 104 may revoke membership, and revoked memberships may be logged and/or notifications for revoked memberships may be generated.

In the example of FIG. 1, the group of trusted independent systems (e.g., one or more trusted VMs from VMs 101 and VMs 102, which may be referred to as “nodes”) may adhere to a shared state Byzantine agreement protocol. In general, a Byzantine agreement protocol is a type of consensus protocol designed to tolerate Byzantine faults, e.g., failures in which nodes behave unpredictably, maliciously, and/or inconsistently. For example, an example Byzantine fault may be a scenario in which one or more nodes provide conflicting information or act maliciously (e.g., due to bugs, corruption, or attacks). In some examples, node failure and node restart may be considered non-Byzantine faults. Example Byzantine faults may include, but are not limited to, local OS instance Denial of Service (DOS), non-Byzantine node (DOS), cluster (DOS), impersonation of a non-Byzantine node tampering of owned state (e.g., owned by a Byzantine node), tampering of non-owned state (e.g., not owned by a Byzantine node), exclusion of a non-Byzantine node from the group, inclusion of other Byzantine nodes into the group, etc. Thus, a Byzantine agreement protocol may ensure that the group of trusted independent systems may still agree on a single, consistent state despite such faults, and that the group of trusted independent systems may handle malicious nodes and/or faulty behavior without compromising the consistency and integrity of the shared state. Thus, in the example of FIG. 1, the members of the group of trusted independent systems (e.g., one or more VMs from VMs 101 and VMs 102) may operate independently from each other, but may agree on a shared state of the SDV system (e.g., the shared state may include information such as service status, configuration data, transaction logs, etc.). In some examples, each member of the group of trusted independent systems may maintain a local copy of this state, which may reflect the group's collective understanding.

Specifically, members of the group of trusted independent systems may only index information about various services and clients running across host OS 114. Different nodes or services (e.g., OS instances, or trusted VM(s) running in a particular OS instance), though, may operate on different versions of data or state. As such, all information pertaining to services and clients running on a particular OS instance may be “owned” by the VM running in the same OS instance. That is, each trusted independent system from the group of trusted independent systems (e.g., each trusted VM) may be the sole “source of truth” about services and clients running within the same OS instance. Specifically, within the group, each trusted independent system (e.g., VM, node) may own a subset of database 110 (which may store information pertaining to services and clients running on the same OS instance), and each subset of database 110 may be owned by exactly one trusted independent system (e.g., a one-to-one relationship may exist). In typical distributed systems concerned with Consistency, this one-to-one relationship may not exist. For example, a distributed system concerned with Consistency may have multiple nodes managing a single resource, or database, such as a database in which each node has a replica of the database (or at least a partial replica), each node may perform Read and Write operations on any entry in the database, and each node may operate with the same trust as other nodes (e.g., there may not be any malicious nodes). Conversely, in accordance with the techniques of this disclosure, each trusted independent system (e.g., VM, node) from the group of trusted independent systems may have a complete replica of database 110, may perform Read operations on any entry in database 110, but may only perform Write operations on the entries in database 110 that the respective trusted independent system controls.

As such, the group of trusted independent systems included in computing system 100 may be architecturally different from most cloud-based distributed systems, and the concepts of Strong/Eventual Consistency may not apply. Instead, a concept of “Implicit Consistency” may be applied, in which each trusted independent system from the group of trusted independent systems may be solely responsible for maintaining and updating service information pertinent to its own OS instance. In this way, if a VM disconnects from the group, it may be assumed that the corresponding OS instance is down, and any information related to the services and clients on the OS instance may or may not be updated across the group. In some examples, any services and clients running on the OS instance may not be able to re-authenticate and/or re-authorize to other services and clients across the group.

As such, the group of trusted independent systems may adhere to a fault-tolerant consensus protocol, e.g., a shared state Byzantine agreement protocol, in which any given independent system cannot operate with the same trust as other independent systems. In this way, the group of trusted independent systems may maintain a consistent shared state, even when some group members behave maliciously and/or unpredictably, thus ensuring robustness, security, and reliability across computing system 100.

In general, to further manage and coordinate members of the group of trusted independent systems, group manager 104 may implement a group membership protocol, e.g., a distributed protocol. In some examples, the protocol may track the state of which independent systems are active, joining, leaving, or failing within the group, and for ensuring consistent communication and coordination between the members of the group. Some example protocols include, but are not limited to, JGroups, Gossip-based Membership Protocols, Scalable Weakly-consistent Infection-style Membership (SWIM), Byzantine Fault-Tolerant (BFT) Consensus protocols, Practical Byzantine Fault Tolerance (PBFT) protocols, protocols such as Paxos, Raft, ByzCoin, etc.

In general, the group of trusted independent systems may operate in multiple “epochs,” which may refer to distinct periods of time or phases in a protocol. That is, the lifecycle of the group may be divided into multiple epochs. During an epoch, certain activities, such as data exchange or group membership, may be carried out under a specific state or configuration. As such, an epoch may represent a version number or checkpoint of the SDV system's state. In some examples, an epoch may refer to a time period in which a shared secret is valid for communication, and/or where group membership remains static or consistent.

In some examples, the group membership protocol implemented by group manager 104 may include various algorithms. In some examples, the group membership protocol implemented by group manager 104 may include an “initialize” algorithm that may initialize the group of trusted independent systems and start a first epoch. In some examples, each node (e.g., trusted independent system) may be provided a consistent view of a list of group members. In some examples, a cryptographic certificate of membership may be issued for each group member.

In some examples, the group membership protocol may include an “admit” algorithm, which may be executed to include independent systems (e.g., one or more VMs from VMs 101 and VMs 102) into the group. In some examples, a request to execute the admit algorithm may contain a set of “proofs” that provide requisite authentication and attestation for admitting a particular independent system (e.g., VM) into the group of trusted independent systems. The group membership protocol may also include an “evict” algorithm that can be executed to exclude independent systems from the group. In some examples, the request to execute the evict algorithm may contain a set of proofs that provide requisite reasons for eviction of a particular independent system from the group of trusted independent systems.

In some examples, when a new epoch starts, each member of the group of trusted independent systems (e.g., nodes, VMs) must be aware of the new epoch, and align their operations accordingly. In some examples, an epoch may be based on agreement of all trusted independent systems (e.g., nodes, VMs) about a set of messages is a particular epoch. In general, nodes can invoke admit and evict requests during an epoch, but all nodes must come to a consensus of individual requests by the end of the epoch in order for the request to be executed at the end of the epoch. That is, in some examples, if a request to execute the group membership admit algorithm is generated during an epoch, a node (e.g., an independent system) may be admitted to the group of trusted independent systems at the start of the next epoch. In some examples, if a request to execute the group membership evict algorithm is generated during an epoch, a node (e.g., a trusted independent system) may be evicted from the group of trusted independent systems at the end of the current epoch.

In some examples, each member of the group of trusted independent systems (e.g., node, VM) may maintain a key-value store of all service-related information. In general, while each entry in the key-value store may be owned by the independent system itself, the group of trusted independent systems may collectively form a logical global database by aggregating the key-value stores of all independent systems in the group of trusted independent systems. As such, any trusted independent system in the group may query the global database view to discover which services are available, their statuses, etc.

In general, during an epoch, the members of the group of trusted independent systems may not change, e.g., group membership may be static. During the epoch, members of the group may exchange and agree upon messages, such as key-value update messages. In general, a key-value update message may be used for exchanging key-value information from one member to all other members within the group, and may be authenticated, may be indexed monotonically, and may incorporate a form of incremental hashing. In general, incremental hashing may involve building a log history of updates issued by a single member of the group. As such, due to log history and indexing, there may be a total ordering of messages coming from a single group member, and a partial ordering of messages from different members of the entire group. A group member (e.g., trusted VM, node) that receives a key-value update message may acknowledge the message with a proof of commitment (e.g., a signature over the incremental hash to declare its acknowledgement).

Various mechanisms may be used in group membership protocols, including, but not limited to, heartbeat messages (e.g., nodes periodically sending “heartbeat” messages to other nodes to indicate that they are still active, and if a node stops receiving these heartbeat messages from another node, it assumes that the other node has failed), failure detection mechanisms (e.g., if a node does not respond to a message within a certain time window, it is considered down), gossip protocols (e.g., each node randomly selects other nodes to exchange membership information), notifications (e.g., once a membership change occurs, such as node failure, eviction, and/or addition, the protocol may notify the remaining members, which may trigger load rebalancing, redistribution of work, recovery procedures, etc.), and the like. In general, members of the group of trusted independent systems may be required to publish authenticated heartbeat messages (e.g., a key-value update message) during an epoch.

In some examples, all nodes may or may not agree on the exact sequence of messages within an epoch, but all nodes may agree on the sequence of epochs themselves. In some examples, each epoch may be associated with an identifier, and each message may be uniquely attributed to exactly one epoch. In some examples, no two epochs may overlap, i.e., if there is a sequence of three messages (in any member node's view), such as m1, m2, m3, and m1 and m3 are attributed to a first epoch, m2 must also be attributed to the first epoch (e.g., there may not be a case in which m1 is attributed to the first epoch, m2 is attributed to a second epoch, and m3 is attributed to the first epoch).

In the example of FIG. 1, the trusted group of independent systems (e.g., one or more VMs from VMs 101 and 102) may additionally or alternatively adhere to a key agreement protocol, which may be a cryptographic method by which two or more trusted independent systems can securely establish a shared encryption key over communication channels 152, which may or may not be considered secure. The shared key may later be used for encrypted communication between the trusted independent systems without any other entities being able to decipher the messages. In some examples, for each epoch, each member of the group of trusted independent systems may obtain a symmetric 32 byte session encryption key and an asymmetric 32 byte session identity key. Some example key agreement protocols include, but are not limited to, Diffie-Hellman (DH) key exchange, Elliptic Curve Diffie-Hellman (ECDH), Diffie-Hellman Ephemeral (DHE), Station-to-Station (STS) Protocol, Internet Key Exchange (IKE), Transport Layer Security (TLS) Handshake, etc.

As such, in general, members of the group of trusted independent systems may establish a shared encryption key, or “shared secret,” during a key agreement protocol. In some examples, at the start and/or end of an epoch, the group of trusted independent systems may use the group membership protocol and the key agreement protocol to generate the shared secret, which may be valid for a duration of an epoch. Once a shared secret is established, the shared secret may be used to authenticate messages through Message Authentication Codes (MACs) and/or encryption.

In some examples, to generate the shared secret, each trusted independent system may generate a private key, which may not be shared with other trusted independent systems. Each trusted independent system may compute a corresponding public key from their private key and exchange the public key over communication channel 152. Then, each trusted independent system may use its own private key and the received public keys from the other trusted independent systems to compute the shared secret. Due to the mathematical properties of the protocol, each trusted independent system may compute the same secret, even though they may not explicitly exchange the secret.

As an example, assuming an authentication and attestation protocol exists (e.g. using a Diffie-Hellman based handshake), the public-private key pairs can be generated and the shared secret can be computed via a “shared secrets binary tree.” For example, assuming there are N nodes (i.e., N trusted independent systems) and a commutative function F such that F(i,j)=F(j,i); k=F(i,j), the i-th node may select a peer (j), in which i and j may communicate and run the authentication and attestation protocol. A binary tree may be constructed from said commutative function joins. The i and j nodes may or may not be physically close to each other on the network, e.g., the binary tree may be constructed from any arbitrary permutation of joins. The shared secret generated at each level of the binary tree may be copied to the respective level's leaf nodes (e.g., if there are N leaf nodes, then log(n) shared secrets may be kept at each leaf node). Then, the topmost (e.g., root node) shared secret may be used for communication across the nodes.

In some examples, each node, or member of the group of trusted independent systems, may derive a session key based on the shared secret, in which the session key may be used to derive the shared secret that encrypts all messages sent throughout an epoch. In some examples, the session key may be updated for every epoch or “heartbeat.” In some examples, to commit a transaction, a member of the group of trusted independent systems may broadcast a message to all other members of the group of trusted independent systems, and the member that broadcasted the message may wait for an acknowledgement from at least a majority (e.g., more than 50%) of the group before committing the transaction.

In general, the group of trusted independent systems (“nodes”) may guarantee operations occur within a fixed number of Round-Trip Time (RTT) calls due to the design of transaction semantics for epochs. In general, the group of trusted independent systems may be considered to be in an epoch or in an epoch transition. In general, an epoch transition (e.g., a transition in which an epoch starts or stops) may be relatively shorter than an epoch. During an epoch transition, membership changes may occur. In general, nodes may monitor each other for patterns of compromise, to reach consensus, and to eject suspicious nodes from the group. In some examples, node ejection may trigger an epoch transition as part of a group membership change.

A consolidation of database mutations, i.e. commits, may occur during an epoch transition. The subset of database 110 owned by a particular independent system (i.e., node) may be considered the particular independent system's log or local database. From an overall group perspective, though, each epoch may be interpreted as a large database transaction. That is, database state may only change during an epoch, and membership change may only occur during an epoch transition period. In some examples, each node may have a hash map, and each node hash map may only be written to by the node that owns it. In some examples, the collection of hash maps indexed by the nodes may be considered the system state, which may be copied to every node after the commit at the end of an epoch transition. During an epoch, a node may broadcast changes to its owned hash map and hash (e.g., similar to a blockchain node hash operation).

In some examples, communication between the nodes may involve log matching (e.g., if two nodes have the same incremental hashes at the same index, then their logs may be identical in all entries up through the given index), completeness (e.g., if an update is committed in a given epoch, then that entry may be present in the logs of all non-Byzantine nodes, i.e., nodes that behave correctly and do not exhibit faulty or malicious behavior, for all higher-numbered terms), and/or state machine safety (e.g., if a non-Byzantine node has applied an update at a given index to its local database, no other non-Byzantine node may apply a different update for the same index). As such, in general, once an entry is confirmed, it may not be contradicted by any other updates at that index across all non-Byzantine nodes. In this way, the SDV system may maintain a single source of truth for any particular state update, and may recover from failures or partitions more effectively. For example, when a node is admitted or evicted from the group, the action may be replicated and logged across all non-Byzantine nodes to maintain an accurate and agreed-upon group membership list.

As such, each node may be responsible for updating database entries corresponding to its owned services and/or clients. During an epoch transition, the group may determine commits. For example, each node may calculate which hashes have accumulated since the last commit, and there may be a k-threshold (e.g., greater than 50% of the nodes-assumes LAN) whereby agreement above k results in a mesh commit. As an example, if F=a maximum number of failures handled by the system, and N (total number of nodes) is greater than or equal to 3F+1, then k=max(F, ceil((N−1)/3)). The group may use the shared secrets binary tree to determine system consensus state for the changes to the hash collection that occurred during the epoch. The shared secrets binary tree may further be used to find and resolve disagreements with subtrees. In general, the shared secrets binary tree may achieve majority consensus.

In some examples, at the end of an epoch, the key-value store of each node may be checkpointed, e.g., each node may publish a cryptographic proof to establish its checkpoint. In some examples, the checkpoint may be a log commit in a respective node's key-value update history that was published during the epoch and agreed upon by the group. All nodes may synchronize information such that each node is updated to the most recent checkpoint. In general, nodes may not “disagree” with a checkpoint, as the checkpoint may be based on the last key-value update message published and agreed upon during the epoch. In some examples, at the end of an epoch, all agreed-upon membership changes (e.g., admission and/or eviction) may be performed as requested during the epoch. In some examples, all nodes in the group may drop the key-value database of all evicted nodes from their view of the global key-value database, and all newly admitted nodes may be provided with the checkpoint so that their respective local databases can be updated. In some examples, at the end of an epoch, the group of trusted independent systems may coordinate a rekey protocol to rotate the shared secret. A rekey protocol may be a cryptographic process that securely generates a new shared secret key (e.g., rotating the existing shared secret) for communication between group members in the next epoch. In this way, the secret used for encryption may be refreshed after each epoch.

As such, at the end of each epoch, group manager 104 may perform rekeying and membership changes to the group of trusted independent systems. In this way, computing system 100 may ensure confidentiality of communication through a new shared secret and that the correct members (e.g., one or more trusted VMs from VMs 101 and 102) are part of the group for the next epoch.

Thus, in accordance with the techniques of this disclosure, computing system 100 may include communications layer 113 which may manage and facilitate communication between one or more authenticated and attested (i.e., “trusted”) independent systems, such as one or more VMs from VMs 101 and VMs 102, that have been admitted to a group of trusted independent systems. The group of trusted independent systems may adhere to various protocols, such as a shared state Byzantine agreement protocol and a key agreement protocol, in which communication within the group of trusted independent systems may be based on a shared secret key. As such, computing system 100 may only execute service bundles from service bundles 120 and/or external service bundles 121 within a trusted independent system that is a member of the group. In this way, robustness, security, and reliability across computing system 100 may be improved.

Furthermore, in the case of SDVs, services may run on distributed compute instances that constitute logical runtime blocks in the overall SDV system. A shared global data mechanism that works cohesively with these distributed nodes may be a solution to enabling and managing a scalable system architecture. Each runtime block may fail, e.g. due to a fatal service crash or forced reboot for a virtualized operating system instance. It is also possible that an individual instance can be compromised, e.g., an OS instance may not crash but rather may suffer from a malicious attack while staying in group communication with other OS instances. As such, the techniques described herein may address security and fault tolerance challenges in SDV architectures for shared state management across distributed compute instances, as well as declarative data flow and service registry management. That is, the techniques described herein may provide a reliable distributed backbone for shared state (such as service information and runtime interface relationship information) and declarative queries for data, without requiring explicit knowledge of the providing service based on shared state (such as unit types and their implementations) in the SDV platform.

More specifically, in the example of FIG. 1, the group of trusted independent systems may enable query handling from SDV services (e.g., service bundles 120 and service bundles 121) for vehicle-wide state by sharing unit type interface and implementation relationship information throughout the group. In some examples, a variety of standard and/or custom properties may be defined in the SDV system, and these standard and/or custom properties may be queried by a service bundle without knowing the counterparty service providing the data. That is, based on the unit type for a standard or custom property, communications layer 113 may find a service that provides the requested information and query it. As such, in general, communications layer 113 may provide a subsystem that allows services to create declarative queries for vehicle data at runtime.

As shown in the example of FIG. 1, computing system 100 may include workflows storage 115, which may be a database, data store, or any other type of storage component that can store one or more workflows. In general, a “workflow” or an “SDV orchestration workflow” may be a structured representation (e.g., a configuration file, code, or metadata) of sequenced operations that coordinate components of computing system 100 and/or external systems to deliver functionality in an efficient, predictable, and reliable manner. In general, only members of the group of trusted independent systems may be used for workflow execution. In some examples, the group of trusted independent systems may keep track of all SDV orchestration workflows, their state (e.g., running, paused, blocked on available unit type implementations, etc.), and their priorities (e.g., for handling resource contention).

In some examples, each workflow from workflows storage 115 may be specified by a directed acyclic graph (DAG). The distributed systems aspect of SDVs is a key enabler of workflow usage; namely, multiple service implementations for particular unit types can be expected in order to provide parallel processing on different nodes (e.g., trusted independent systems, such as one or more VMs from VMs 101 and VMs 102, that provide an execution environment for implementation of various service methods) or to handle different levels of available capabilities provided across nodes. However, the exact implementation of service methods in a workflow can vary greatly across vehicle architectures in implementation specifics (e.g., variation in device and/or component types, variation in availability of GPU acceleration in specific SDV instances, variation in number and position of devices and/or components in each vehicle SKU, etc.). Furthermore, availability of nodes can vary greatly during runtime (e.g., devices and/or components may be in unusable states, GPUs may be busy with other tasks, SDV instance CPUs may be busy with high priority workloads, clients may be not be in a state to listen to output, etc.). As such, encapsulating a workflow as a dedicated service may require significant rework across a wide variety of vehicle SKUs, and would present significant challenges to third-party developers. Therefore, in accordance with the techniques of this disclosure, each workflow from workflows storage 115 may be specified as a “unit types DAG,” which may eliminate this rework.

More specifically, as unit types may be used as shared data within the group of trusted independent systems, the group of trusted independent systems may keep track of available implementations for each unit type, and may track an index of unit types in the SDV system. Available implementations may be queried at runtime for each unit type involved in a particular workflow. As such, orchestration may be statically specified through unit types and dynamically executed via service discovery. That is, a just-in-time property may exist for the SDV system, as unit type DAG workflows can be specified without knowing implementation-specific details, or even which particular implementations are available a priori, thereby separating SOA orchestration mechanism and policy.

In some examples, while SDV orchestration may provide the right set of available implementations for a unit type at runtime, only a subset of the implementations may be desired due to particular details of the kind of information that implementation may provide. As an example, a particular service bundle may want an available camera stream, but refuse to use one that provides personally identifiable information about the driver (e.g. an in-cabin camera). These restrictions on properties, which may be extrinsic to the unit type definition, but may be relevant to the kind of information provided by implementations, may be considered “resource permissions.” As an example, an example video processing machine learning workflow may specify a particular resource permission as an input workflow constraint (e.g., an input such as “USE_NO_PII_STREAMS). Given a cohesive set of resource definitions for physical capabilities provided by the vehicle (e.g., ECU component outputs, fused outputs of ECU components, etc.) and permission tiers assigned to them, these may be used to finetune any workflow query as input constraints to meet permissions requirements. Furthermore, these permissions may be specified at both an application and system level. For example, a system-level permission manager may enforce emergent authorization by adding additional resource permission constraints at runtime beyond a service's workflow specification.

In general, service discovery via the trusted group of independent systems may be considered a first class element of JIT orchestration; namely, executing a workflow from workflows storage 115 for the first time may require discovering all available implementations for a particular unit type, and recording this information in database 110, which may provide a consistent record of service identities, service registrations, and runtime interfaces across all OS instances in the leaderless distributed system.

As an example, in the example of FIG. 1, VM 101A may host service bundle 120A that defines service unit 117A, which may implement unit type 116. VM 102A may connect to external service bundle 121A that defines service unit 119A, which may also implement unit type 116. In this example, VM 101A and VM 102A may be members of the group of trusted independent systems. Service bundles 120A and 121A may each provide at least one service, which may be the same service or different services. In some examples, computing system 100 may include Electronic Control Units (ECUs) including service bundles (e.g., applications) for managing engine timing, transmission shifting, engine fuel mixture, automatic braking systems, collision avoidance systems, etc. Computing system 100 may include various SDV modules that may control service bundles 120 for vehicle services such as radio and other multi-media operations, user configurable preferences such as interior LED colors and brightness, radar adaptive cruise control, and HVAC and/or climate control settings, such as interior cabin temperature, humidity, fresh-air intake, etc. Furthermore, service bundles 120 and/or external service bundles 121 may not be limited to electric Original Equipment Manufacturer (eOEM) installed and/or Original Equipment Manufacturer (OEM) provided software applications. For instance, a compatible in-vehicle infotainment (IVI) system may be configured to download and install software applications at the request and direction of a user or vehicle owner from an application marketplace.

In one example, VM 101A may provide an execution environment for safety functions of an SVD (e.g., door locks, airbag system, collision avoidance system, self-driving capabilities, etc.), and VM 102A may provide an execution environment for an in-vehicle infotainment (IVI) system. Host OS 114 may execute a DAG workflow from workflows storage 115, in which the DAG includes a plurality of nodes and a plurality of edges. In general, each node from the plurality of nodes may be associated with a respective unit type from the plurality of unit types. As an example, a first node may be specified by the DAG workflow as being associated with unit type 116. As such, while executing the workflow, host OS 114 may provide, to communications layer 113, a query, wherein the query includes a request to discover at least one available implementation of unit type 116. In some examples, executing the workflow for the first time may require discovering all available implementations for unit type 116, and recording this information in database 110.

As shown in FIG. 1, database system 110 may store information pertaining to different services provided by service bundles 120 and/or external service bundles 121. In some examples, unit type names may be used to discover service bundles and/or service units that can implement a specific unit type. In some examples, the implementations of the unit types may be stored in database system 110. Database system 110 may provide a mapping between service bundles (and/or service units) and unit types. In some examples, a service bundle and/or service unit may be expressly linked with a unit type. In some examples, service bundles and/or service units may additionally or alternatively be uniquely associated with network addresses recorded in database system 110. As described above, each node (e.g., each trusted independent system, such as one or more VMs from VMs 101 and VMs 102) may be responsible for updating database 110 entries corresponding to its owned services and/or clients. As such, in some examples, a trusted independent system may only alter, update, and broadcast data that is associated with a particular service bundle and/or service unit that the trusted independent system provides an execution environment for.

In some examples, communications layer 113 may register service bundles and/or service units for each unit type in database system 110 (i.e., database system 110 may act as a centralized registry and may include a list of registered service bundles and/or service units indexed by their respective implemented unit types). That is, in the example of FIG. 1, communications layer 113 may identify and register service bundle 120A and external service bundle 121A for unit type 116 in database system 110. Database system 110, as shown, may include a list including service bundles indexed by the unit types.

As further shown in the example of FIG. 1, in some examples, database 110 may store an entry for service bundle 120A that indicates service bundle 120A implements unit type 116 and is assigned to public key 124A, instance identifier (ID) 126A, and service ID 128A. Database 110 may also store an entry for external service bundle 121A that indicates service bundle 121A implements unit type 116 and is assigned to public key 124B, instance ID 126B, and service ID 128B. In some examples, the public key stored for each service bundle may be the public key assigned to the independent system in which the service bundle is being executed. In some examples, the public key stored for each service bundle may be the public key assigned to the trusted independent system that provides an execution environment for the service bundle. In some examples, the instance ID stored for each service bundle may be the instance ID for the OS instance (e.g., the independent system) in which the service bundle is being executed. In some examples, the service ID stored for each service bundle may be a service name or other identifier. In some examples, database 110 may store different and/or additional information pertaining to the group of trusted independent systems and/or the services they execute. For example, database 110 may store information indicative of available implementations for each unit type. In general, a service bundle and/or a service unit defined by a service bundle may implement a unit type. As such, in some examples, an “available implementation” may be considered an available service bundle and/or an available service unit, or a service bundle and/or a service unit that is not currently being executed within a trusted independent system, but can be executed within a trusted independent system. In some examples, an “available implementation” may be considered an available trusted independent system that is not currently being executed, but can be executed to run an available service bundle and/or service unit to provide a service.

As such, the group of trusted independent systems may keep track of available implementations for unit type 116 and any other unit types specified by the workflow. In general, available implementations may be queried at runtime for each unit type involved in a particular workflow. Continuing the example, to provide the query including a request to discover at least one available implementation of unit type 116, host OS 114 may query database 110 managed by communications layer 113 to determine whether one or more independent systems from the plurality of independent systems that implement unit type 116 are available. For example, host OS 114 may query database 110 to determine whether one or more members of the group of trusted independent systems (e.g., one or more VMs from VMs 101 and VMs 102) that implement unit type 116 are available. In the example of FIG. 1, host OS 114 may determine that VM 101A that provides an execution environment for service bundle 120A is available. Responsive to determining that VM 101A, which implements unit type 116, is available, host OS 114 may select VM 101A and, while executing the workflow, execute VM 101A. In some examples, host OS 114 may determine that multiple trusted independent systems implement a particular unit type and are available and/or are unavailable. For example, while service bundle 120A may be considered to implement unit type 116, different service bundles across computing system 100 and/or different external service bundles in communication with computing system 100 may also simultaneously implement unit type 116. That is, for example, service bundle 120B hosted on VM 101B and service bundle 120C hosted on VM 101B may also simultaneously implement unit type 116. As such, VHAL proxy 105 and communications layer 113 may function to integrate multiple trusted independent systems. In some examples, host OS 114 may select an available trusted independent system based on one or more resource permissions specified by the workflow. In some examples, responsive to determining no trusted independent systems that implement a specified unit type are available, host OS 114 may pause the execution of the workflow.

In some examples, the DAG workflow may specify a plurality of edges, in which each edge from the plurality of edges may represent a dependency between at least two nodes. In some examples, service bundle 120A may be a distributed service bundle hosted on VM 101A that is composed of services that may call other services and may provide the functionality of service bundle 120A. In some examples, service bundle 120A may execute services that call other services executing in different service bundles hosted on the same VM (i.e., VM 101A), and/or other services executing in different service bundles hosted on different VMs (e.g., VMs 101B-101N and/or VMs 102).

In general, VHAL proxy 105 and communications layer 113 may communicate with various components of computing system 100 via one or more communication channels 152 (e.g., through a specific network address or bus system within computing system 100). In some examples, VHAL proxy 105 may manage vehicle properties and services and perform data abstraction by using database system 110. VHAL proxy 105 may abstract hardware specifics and provide a consistent interface to host OS 114 and application software, such that host OS 114, service bundles 120A-120N, and/or external service bundles 121 may interact with various hardware components without needing to manage hardware-specific details. That is, VHAL proxy 105 may be considered an abstraction layer with a standard interface that different hardware vendors can implement; as such, VHAL proxy 105 may allow for different independent systems to be agnostic about lower-level driver implementations and to implement functionality without affecting or modifying higher level systems.

In some examples, database system 110 may store information for reusable components including standard interfaces for implementation and multiparty communication. As an example, a service to control HVAC features may have a reusable part (e.g., a PID controller to manage auto temperature control settings), and a part that is specific to a particular architecture (e.g., how to send out a target temperature to physical hardware and how to read results back from the physical hardware). A supplier of components for HVAC control may want to build a reusable service that can be targeted to different OEMs. To do so, the supplier may build the business logic and expect each OEM to supply certain interfaces that control the specific physical entities involved in the service. VHAL proxy 105 may partition service integration components or logic (e.g., components that are specifically designed to interface with ECU components and only communicate with interfaceable SDV logic) from service interfaceable components or logic (e.g., components that provide the interfaces that other services would use). In this way, VHAL proxy 105 may facilitate a scalable Service-Oriented Architecture (SOA) where first party or OEM services can rely on other service components without accidentally including incidental implementation details in business logic, without inducing vendor lock-in, and without requiring extensive integration or validation testing for service interconnection.

Furthermore, in some examples, VHAL proxy 105 executing within a vehicle may provide a mapping between vehicle services and various vehicle properties, such as vehicle speed, vehicle thermostat settings, vehicle braking status, etc., in which the mappings may be stored in database system 110. In some examples, one or more “unit type maps” may be stored in database system 110. In general, a unit type, e.g., an interface, may declare methods that a service bundle and/or service unit may implement (e.g., the service bundle and/or service unit may define how the methods declared by the interface are actually performed). In some examples, methods across multiple unit types may be regrouped to provide an “interface view” that is more straightforward for some service bundles, e.g., applications. As an example, a speed profile from an “ADASMetadataType” unit type may be combined with acceleration information from an “IMU” unit type and RPM information from an “Engine” unit type to provide a “vehicle motion” interface view. As such, a unit type map may be an SDV-level natively supported interface view where each view method calls a corresponding method for the linked unit type when invoked. In this way, unit type maps may solve challenges associated with sharing a set of common methods for a use case with one permission. That is, in some examples, a service may not need to receive permissions across a variety of different unit types and services to use these common methods; rather, a service may receive permissions to use a unit type map, and permissions may be granted to use the linked unit type methods.

Furthermore, as a native runtime system backing an SOA architecture, the SDV may not have a managed runtime nor a native object-oriented representation of the system. That is, the runtime may be more functionally-oriented where the unit types admit a type theory, e.g., each service may take one unit type and the hierarchy of unit types may be flat. In general, unit type maps may provide an encapsulated representation of service interactions. As such, the behavioral interactions between a set of services may change without changing the underlying services, and service interfaces may be loosely coupled from each other. Furthermore, a unit type map may provide a view for external APIs that mask the underlying complexity of the routing and call structures for marshalling data to and from SDV. The unit type map may also abstract away the internal vehicle-specific SOA structure and configuration from external systems or remote entities.

As such, in the example of FIG. 1, host OS 114 may execute one or more trusted independent systems based on a workflow from workflows storage 115 and a unit type map stored in database 110. In some examples, a workflow may specify a particular unit type map. Therefore, in the example of FIG. 1, prior to executing VM 101A and/or service bundle 120A, host OS 114 may determine whether VM 101A and/or service bundle 120A has permissions to use a particular unit type map, such as a unit type map for unit type 116. Assuming sufficient permissions, after executing VM 101A to execute the service provided by service bundle 120A, host OS 114 may determine, based on the workflow and/or the unit type map, a dependency between VM 101A and another node. However, the dependency may not need to specify a particular node (e.g., trusted independent system) and/or service method to execute next, and instead may only specify the unit type associated with the workflow and/or the unit type map. For example, after executing VM 101A to provide the implementation of unit type 116 by service bundle 120A, host OS 114 may provide another query including a request to discover at least one other available implementation of unit type 116 that is specified by the unit type map. As an example, in the example of FIG. 1, host OS 114 may determine that VM 102A that provides an execution environment for external service bundle 121A is available. Responsive to determining that VM 102A, which implements unit type 116, is available, host OS 114 may select VM 102A and, while executing the workflow, execute VM 102A.

In some examples, in addition to database 110, computing system 100 may include one or more data storage components dedicated to storing various types of information. For ease of illustration, although FIG. 1 shows database 110 as storing a specific set of information, in some examples, this set of information may be considered a subset of the information stored in database 110. That is, in general, database 110 may store any of the information described herein, and may store additional information not described herein but is pertinent to the SDV system. For example, in some examples, database 110 may store information pertaining to vehicle properties, vehicle service permissions, mappings, access control lists, etc. In some examples, assuming sufficient permissions, communications layer 113 may communicate updated properties to various trusted independent systems (e.g., vehicle subsystems) based on mappings stored in database 110. For instance, if the vehicle temperature is increased at a user interface, communications layer 113 may communicate the increased temperature property to the appropriate vehicle subsystem based on the mapping. In a similar way, a software application executing at the infotainment system may retrieve updated temperature information from communications layer 113. In other instances, a software application installed on the infotainment system may communicate a new temperature setting to communications layer 113, which in turn may be communicated to the appropriate vehicle subsystem to alter the temperature of the vehicle.

In some examples, VHAL proxy 105 may further retrieve and manage data from hardware components across the vehicle and perform data abstraction. For instance, consider an example where service bundle 120A is a service bundle for a vehicle speedometer. In such an example, the implementation of unit type 116 by service bundle 120A may be stored in database system 110, in which database system 110 may provide mapping between service bundle 120A and other service bundles across computing system 100 and/or in communication with computing system 100 that implement unit type 116. Continuing this example, VHAL proxy 105 may read a current speed property from service bundle 120A and may store that information in database system 110. Communications layer 113 may then relay the current speed property to another service bundle, e.g., an OEM provided or third-party provided software application, or another independent system that implements unit type 116. As an example, communications layer 113 may be configured to iteratively report current vehicle speed to an auxiliary speedometer readout provided to a navigational application executing via an infotainment system, such as service bundle 121A.

Thus, in general, the techniques described herein may provide multiple solutions for various challenges associated with security, reliability, and robustness of SDV systems. For instance, by authenticating and attesting independent systems to a trusted leaderless group, and by having the group adhere to protocols such as a shared state Byzantine agreement protocol, tolerance of failures (e.g., systems behaving unpredictably, maliciously, and/or inconsistently) may be improved. The techniques describe may provide solutions for employing secure group messaging mechanisms, dynamic group membership management, and self-monitoring for compromise detection across distributed compute instances in the leaderless distributed system at runtime. The techniques described may provide solutions for employing automatic management and coordination mechanisms for handling Byzantine fault tolerance among all compute instances in the leaderless distributed system at runtime. Furthermore, the techniques described may provide a solution for maintaining a consistent record of service identities, service registrations, and runtime interfaces across all compute instances in the leaderless distributed system, as well as a runtime consensus and commit mechanisms for shared data across all compute instances in the leaderless distributed system. The techniques described may provide a declarative data querying mechanism for services based on vehicle-wide shared data across all compute instances in the leaderless distributed system.

Additionally, one or more compute instances may be non-local compute instances, e.g. infotainment units, handheld phone devices, or cloud instances, in which these non-local compute instances may be used as subgroups of the overall shared state subsystem. That is, given the dynamic group membership capability and Byzantine fault tolerance guarantees, in some examples, gateway components (e.g., remote entities, such as external systems that execute external service bundles 121) of the same type (e.g. infotainment units, cloud instances) can be bundled together as “gateway groups” within the larger trusted leaderless group. For instance, if external service bundle 121A and external service bundle 121B are both applications for an IVI system, they may be grouped together in an IVI subsystem group. In some examples, one or more compute instances may be ephemeral compute instances, such as parking meters, traffic control mechanics (e.g. traffic lights, traffic diversions, traffic speed checks, etc.), other vehicles in nearby proximity, etc., in which these ephemeral compute instances may be present in the distributed system as an ephemeral subgroup to communicate and share state with the overall distributed system. By keeping components of the same type in the same subgroup, subsystems within the larger trusted leaderless group may be optimized, as components of each subgroup may have similar runtime characteristics (e.g. network latency distribution, failure modes, etc.).

Furthermore, by executing trusted independent systems on the basis of unit types (e.g., workflows and/or unit type maps), system architects from OEM may focus on composable service design and encapsulating services via the unit types. Further, system engineers at OEMs may focus on workflow performance and work with system architects to finetune SDV instance configurations and service design, such as to improve workflow performance. Lastly, application developers (at OEMs, third party, etc.) may focus on building reusable workflows as core components along with dedicated application-specific services for differentiated components.

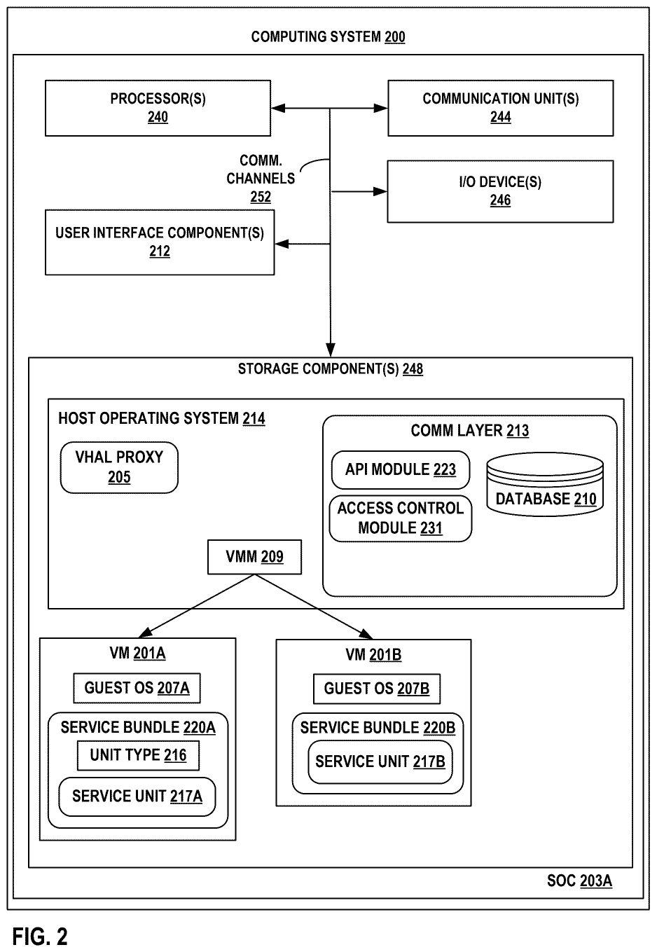

FIG. 2 illustrates another example computing system including an operating system that executes a plurality of trusted independent systems, in accordance with one or more techniques of this disclosure. As shown in FIG. 2, the example computing system includes vehicle computing system 200. For the purposes of clarity, one or more components of vehicle computing system 200 are described below as an example of vehicle computing system 100 as illustrated in FIG. 1. Vehicle computing system 200 may be included within an SDV and provide one or more types of functionalities for the SDV. FIG. 2 illustrates only one example of vehicle computing system 200, and many other examples of vehicle computing system 200 may be used in other instances and may include a subset of the components included in example vehicle computing system 200 or may include additional components not shown in FIG. 2.

Vehicle computing system 200 may include one or more computing devices, such as a mobile phone, a tablet computer, a laptop computer, a desktop computer, a server, a mainframe, a set-top box, a television, a wearable system, an automation system or system, a gaming system, a media player, an e-book reader, a mobile television platform, an automobile navigation or infotainment system, vehicle control system, or any other type of mobile, non-mobile, wearable, and non-wearable computing device.

As shown in the example of FIG. 2, vehicle computing system 200 includes one or more processors 240, one or more communication units 244, user interface component 212 (hereinafter “UIC 212”), one or more input/output (I/O) device(s) 246, and one or more storage components 248. Storage component 248 may include host OS 214, which may further include communication layer 213 including database 210, application programming interface (API) module 223, and access control module 231, VHAL proxy 205, and virtual machine manager (VMM) 209. VMM 209 may manage the execution of VM 201A and VM 201B on guest OS 207A and guest OS 207B, respectively. As shown in the example of FIG. 2, VM 201A may be configured to host service bundle 220A defining service unit 217A, and VM 201B may be configured to host service bundle 220B defining service unit 217B. As further shown in the example of FIG. 2, host OS 214 may be executed on SOC 203A.

Communication channels 252 (illustrated as “COMM. CHANNELS 252” in FIG. 2) may interconnect each of the components of FIG. 2 for inter-component communications (physically, communicatively, and/or operatively). In some examples, communication channels 252 may include a system bus, a network connection, an inter-process communication data structure, or any other method for communicating data. For example, communication channels 252 may interconnect storage components 248 to other components for vehicle computing system 200. In another example, communication channels 252 may interconnect I/O devices 246 to other components of vehicle computing system 200.

One or more I/O devices 246 of vehicle computing system 200 may receive input. I/O devices 246 may receive input such as tactile, audio, and video input. I/O devices 246 of vehicle computing system 200, in one example, includes a presence-sensitive display, touch-sensitive screen, mouse, keyboard, voice responsive system, video camera, microphone or any other type of system for detecting input from a human or machine. One or more I/O devices 246 of vehicle computing system 200 may generate output. I/O devices 246 may generate output such as tactile, audio, and video output. I/O devices 246 of vehicle computing system 200, in one example, includes a presence-sensitive display, sound card, video graphics adapter card, speaker, liquid crystal display (LCD), organic light-emitting diode (OLED) display, a light field display, haptic motors, linear actuating systems, or any other type of system for generating output to a human or machine.

UIC 212 of vehicle computing system 200 may be hardware that functions as an input and/or output system for vehicle computing system 200. For example, UIC 212 may include a display component, which may be a screen at which information is displayed by UIC 212 and a presence-sensitive input component that may detect an object at and/or near the display component.

One or more communication units 244 of vehicle computing system 200 may communicate with external systems via one or more wired and/or wireless networks by transmitting and/or receiving network signals on the one or more networks. Communication units 244 may include a network interface card (e.g., an Ethernet card), an optical transceiver, a radio frequency transceiver, a GPS receiver, or any other type of system that can send and/or receive information. Communication units 244 may also include short wave radios, cellular data radios, wireless network radios, as well as universal serial bus (USB) controllers. In some examples, vehicle computing system 200 may communicate using only internal communications when communication units 244 lose connectivity to external networks. For example, due to the mobile nature of a vehicle in which vehicle computing system 200 is integrated, vehicle computing system 200 may enter areas with little to no cellular or wireless internet access. Communication units 244 may then be unable to provide external connectivity to one or more components of vehicle computing system 200 such as processors 240.

Vehicle computing system 200 includes storage components 248. Storage components 248 may include one or more types of storage such as solid-state storage, random access memory (RAM), hard disk drives, eMMC memory, optical discs, floppy discs, flash memories, or forms of electrically programmable memories (EPROM) or electrically erasable and programmable (EEPROM) memories, and other types of storage. Storage components 248 may store data for one or more programs and processes. Storage components 248 of vehicle computing system 200 may also include host OS 214, which may further manage communication layer 213, VHAL proxy 205, and VMM 209.

Host OS 214 may include an operating system kernel such as a Linux® kernel, Windows NT kernel, Unix-based kernel, hybrid kernel, or another proprietary operating system kernel. Host OS 214 may be executed by processors 240. Processors 240 may be one or more types of processors such as application-specific integrated circuit (ASIC), field-programmable gate array (FPGA), reduced instruction set computer (RISC) processor, general-purpose processor, or other type of processor. Processors 240 may include one or more cores and/or chiplets configured to implement functionality and/or execute instructions within vehicle computing system 200. For example, one or more processors 240 on vehicle computing system 200 may receive and execute instructions stored by one or more storage components 248 that execute the functionality of host OS 214. The instructions executed by one or more processors 240 may cause vehicle computing system 200 to store information within one or more storage components 248 during program execution. Examples of one or more processors 240 include application processors, display controllers, sensor hubs, and any other hardware configured to function as a processing unit. One or more processors 240 may execute instructions of host OS 214 to perform actions or functions. Host OS 114 may be executed on a centralized computing system module such as a vehicle control unit (VCU), System On a Chip or “SOC” type processing circuitry type device, such as SOC 203A, or a collection of interconnected components, such as a central processing unit (CPU) for executing operations and computer instructions, memory for storing computer instructions, Input/Output (I/O) components, communication busses, signal processing components, etc.

As described herein, VM 201A and VM 201B may host a plurality of applications (i.e., software packages) for services provided across vehicle computing system 200. For example, guest OS 207A may execute service bundle 220A, which may be an infotainment system that provides functionality such as media playback, vehicle information, etc. In another example, guest OS 207B may execute service bundle 220B, which may provide vehicle diagnostics functions and analyze data generated by components of an SDV in which vehicle computing system 200 is incorporated. As described above, each application may define one or more service units that provide functionality of the application, such as service unit 217A and service unit 217B.

In some examples, the service units, applications, and other components described herein may be interconnected through various types of in-vehicle networks used throughout the automotive industry, including but not limited to a Controller Area Network (CAN), Media Oriented Systems Transport (MOST), Local Interconnect Network (LIN), Flexray Automotive Communication Bus (FACB), Automotive Ethernet, Onboard Automotive LTE, vehicle based WI-FI, and vehicle based BLUETOOTH. As described herein, in some examples, vehicle computing system 200 may be configured to communicate outside of a vehicle to remote services, such as payment devices for toll roads, satellite-based radio services, and cloud services for vehicle computing system 200.

In general, VHAL proxy 205 and communications layer 213 may allow service bundles and/or service units across vehicle computing system 200 and/or external to vehicle computing system 200 to indirectly discover implementations of standardized unit types by other service units, no matter the independent subsystems in which they may be included (e.g., Electronic Control Unit (ECU) type automobile subsystems, Software Defined Vehicle (SDV) type automobile subsystems, external subsystems, etc.). Some example service bundles may include ECUs, SDV modules, Anti-lock Braking System (ABS) modules, Transmission Control Unit (TCU) modules, body control modules, connected and autonomous electric vehicle modules, door lock controllers, heating, ventilation, and air conditioning (HVAC) systems, pedestrian protection units, airbag management systems, navigation head units, vehicle dashboard systems, power window controllers, automatic engine start systems, radar systems, rain sensors, etc.

The various service units may be defined by applications, e.g., service bundles, hosted within vehicle computing system 200 or external applications hosted within external systems and provide different services across a vehicle. The service bundles and/or service units described herein may be unaware of each other; that is, vehicle services provided by the service bundles and/or service units may not be hard-coded to vehicle interfaces defined across vehicle computing system 200 and external systems. In general, each service bundle and/or service unit may be dynamically loaded or updated with standardized interface implementations made by other service bundles and/or service units through communications layer 213, e.g., based on unit types standardized by VHAL proxy 205 and/or unit type maps stored in database 210. That is, when executing, for example, an application that defines an HVAC system and window controller, a guest OS may load or update the HVAC system and window controller with a set of standardized implementations retrieved from database 210 by communications layer 213. The implementations may include an implementation of a standardized unit type that is implemented by the HVAC system and an implementation of a standardized unit type that is implemented by the window controller, in which the implementations may be retrieved from one or more other trusted independent systems.

As shown in the example of FIG. 2, communication layer 213 may further include application programming interface (API) module 223. API module 223 may provide a uniform API for registering and discovering service bundles and/or service units defined across vehicle computing system 200 and external systems in communication with vehicle computing system 200 (e.g., Publisher/Subscriber (Pub/Sub) message types, remote procedure call (RPC) interfaces, runtime interfaces or inter-process communication (IPC) interfaces, etc.). In some examples, API 223 may be provided in various forms or by various services to support RPC interactions and/or Pub/Sub systems, such as XML-RPC, JSON-RPC, cloud-based Pub/Sub services, Advanced Message Queuing Protocol (AMPQ), Simple Notification Service (SNS), Simple Queue Service (SQS), and the like.

Communication layer 213 may further include access control module 231, which may provide access control lists that govern the permissions of applications included in vehicle computing system 200 and/or external applications to implement certain unit types. In general, a unit type may also be declared as one or more of a public type, a protected type, and a local type, in which the unit type may be declared in accordance with an inter-process communication (IPC) policy including information indicative of one or more trusted independent systems (e.g., VMs), service bundles, and/or service units authorized to implement the unit type.

In some examples, the IPC may include information pertaining to the operations present between a server and client and their signature as well as how access is granted for each operation. Specifically, in some examples, for an interface, the IPC policy (which may be written by a developer) may determine the methods a server needs to provide and the types it can take. The IPC policy may further determine the permissions needed for access to the methods. In some examples, prior to granting a service permission to use a unit type map stored in database system 210, communications layer 213 may determine the permissions granted to the particular service using the information stored in access control module 231. In some examples, the IPC policy may be compiled at build time but checked at runtime. As such, host OS 214 may treat IPC interface specifications as extensible “first class citizens” in vehicle computing system 200, i.e., IPC interface specifications may be given a high level of importance and integration within vehicle computing system 200. Thus, the IPC interfaces described herein may be built into the core of host OS 214 with robust support and accessibility.

For example, with a runtime interface mechanism, an interface is its own entity and may be tracked by host OS 214 along with associated permissions and compatibility. As such, a loose coupling may be provided between servers and clients. For example, when a server declares an implementation of an interface, the server's implementation may be checked at runtime for compatibility with the interface definition and relevant permission privileges. Host OS 214 may manage the means of transport and discovery between servers and clients via communication layer 213. Interested clients may query communication layer 213 using IPC interfaces to discover and connect with servers that implement the provided interface. Then, permissions enforcement may be performed at runtime as part of an enforcing policy.

Regarding permissions, a public type may be a unit type that can be implemented by any service units regardless of the service bundle associated with a particular service unit or the VM hosting the service bundle. A protected type may be a unit type that can only be implemented by an authorized service bundle and/or service unit. A service unit may be considered an authorized service unit if the standardized unit type is declared within the same service bundle as the service unit or if the unit type provides an access control list (ACL) that allows the service unit's service bundle to implement the standardized unit type. For example, a particular Pub/Sub message type may be a protected type, in which access control module 231 may determine, based on an ACL provided by the protected Pub/Sub message type, whether a service bundle is authorized to implement the protected Pub/Sub message type. As such, access control module 231 may restrict the number of service bundles and/or service units that can implement a particular standardized unit type, define which service bundles can access a service, define the conditions in which a service bundle can access a service, and define which operations a service bundle can perform. In this way, the security of communication layer 213 and vehicle computing system 200 may be enhanced.

In general, service bundles and/or service units may each implement a unit type declared by an service bundle included in different trusted independent systems and is standardized by VHAL proxy 205. As an example, service bundle 220A may declare unit type 216, which may be an RPC interface type, and define service unit 217A, which may be an RPC server that implements the RPC interface type. An RPC interface may allow a software package to cause a procedure, subroutine, or method to execute in another address space. As an example, service unit 217A may define a procedure that can be called by other software packages included in other trusted independent systems.

For example, service unit 217B, which may be defined by service bundle 220B hosted on VM 201B and executed by guest OS 207B, may be authorized to implement the RPC interface type declared by service unit 217A, and may act as an RPC client that makes requests to service unit 217A, such that service unit 217B can perform the procedure defined by service unit 217A. However, as described herein, the specific communication process and interaction between service unit 217A and service unit 217B may be abstracted by VHAL proxy 205 and/or communication layer 213. Specifically, for the procedure defined by service unit 217A, VHAL proxy 205 may separate interfaceable SDV logic (e.g., logic that provides the interface that service unit 217B would use) from isolated integration logic (e.g., logic that is specifically designed to interface with service unit 217A and be optimized for the specific vehicle architecture it runs on). As such, VHAL proxy 205 may standardize the RPC interface type declared by service unit 217A, and store the standardized RPC interface type implementation in database system 210. Service bundle 220B may provide a command to communication layer 213 indicating a request for implementations of the specific standardized RPC interface type, in which communication layer 213 may fetch the implementation from database system 210. Service unit 217B may be loaded and executed with the procedure defined by service unit 217A and standardized by VHAL proxy 205. Service unit 217B may further be registered by communication layer 213 in database system 210 under the standardized RPC interface type name.

In another example, service unit 217A may be a Pub/Sub Publisher, and service unit 217B may be a Pub/Sub Subscriber. Service bundle 220A may declare a specific unit type such as a Pub/Sub message or topic type to which service unit 217A can publish. Service unit 217B may be subscribed to a Pub/Sub message or topic type standardized by VHAL proxy 205, in which service unit 217B may receive any messages (e.g., data or metadata specific to an application's needs) published to the standardized message or topic type by service unit 217A. Similar to the RPC example above, the specific communication process and interaction between service unit 217A and service unit 217B in this Pub/Sub example may be abstracted by VHAL proxy 205 and communication layer 213. Specifically, service bundle 220B may provide a command to communication layer 213 indicating a request for implementations of the specific standardized message or topic type, in which communication layer 213 may fetch the implementation from database system 210. Service unit 217B may be loaded and executed with a subscription to service unit 217A. Service unit 217B may further be registered by communication layer 213 in database 210 under the standardized Pub/Sub message or topic type name.

In general, database 210 may be updated with new service bundle and/or service unit registrations during vehicle computing system 200 operation. Any service bundle and/or service unit authorized to implement a specific standardized unit type may discover other service bundles and/or service units implementing the specific standardized unit type via communication layer 213. For instance, at runtime, service bundle 220A may provide a string input to communication layer 213 that specifies a request for one or more implementations of one or more standardized unit types.

As an example, consider an example application in which service bundle 220A declares a public interface “TirePressureMsg,” (which, for example, may have a unit type name of “TirePressureMsg”). Service bundle 220A may define a service unit 217A that implements TirePressureMsg for a specific hardware sensor configuration. Service unit 217A may be registered by communication layer 213 in database 210 under the unit type name of “TirePressureMsg.” For the specific implementation of TirePressureMsg by service unit 217A, VHAL proxy 205 may separate interfaceable SDV logic (e.g., logic that provides the TirePressureMsg interface that service unit 217B would use) from isolated integration logic (e.g., logic that is specifically designed to interface with service unit 217A and be optimized for the specific vehicle architecture it runs on). As such, VHAL proxy 205 may standardize the TirePressureMsg interface declared by service unit 217A, and store the standardized TirePressureMsg interface implementation in database system 210.

Service bundle 220B, which may be executing within a different independent system, may provide a command to communication layer 213 indicating a request for an implementation of the unit type “TirePressureMsg.” Provided that access control module 231 determines that service bundle 220B is authorized to implement standardized unit type TirePressureMsg, communication layer 213 may query database 210 using the command input, and fetch the standardized implementation of TirePressureMsg. For example, communication layer 213 may return the reusable, interfaceable business logic provided by service unit 217A. As shown in this example, service bundle 220B and service bundle 220A may be “loosely coupled” or “decoupled.” That is, the applications and other components of vehicle computing system 200 may be included in different independent systems and may interact through an intermediary such as VHAL proxy 205 and communication layer 213, in which VHAL proxy 205 and/or communication layer 213 may abstract away any knowledge the applications and components have of each other. Vehicle computing system 200 may be considered to have a Service-Oriented Architecture (SOA), in which services or applications across vehicle computing system 200 may interact with each other through communication layer 213, but do not need to be aware of the internal workings of the other systems, services, or applications they interact with.

Continuing the example above, while executing service bundle 220B, guest OS 207B may load service unit 217B with the standardized implementation of ‘TirePressureMsg’. For example, service unit 217B may control a light bulb configured to light up when a tire pressure message is generated (service unit 217A, for instance, may be responsible for determining the exact message that is generated). Service unit 217B may also be registered by communication layer 213 in database 210 under the standardized unit type name of ‘TirePressureMsg.’

As such, the techniques described herein may facilitate continuous runtime updates of interface implementations across host OS 214, and may improve the framework for dynamic services, particularly in SDV architectures. The use of runtime interface enforcement may provide a solution to the current challenges in SDV architectures relating to updatability and service communication across different hardware components, as new components (internal or external) may be dynamically integrated into vehicle computing system 200 without requiring a full recompilation or restart. This may provide an advantage over vehicles lacking host OS 214, as although these vehicles may have an infotainment system that communicates with various vehicle services, the systems of these vehicles may be highly fragmented due to the use of different and sometimes incompatible communication modes between vehicle services. Furthermore, vehicles lacking host OS 214 are typically pre-configured at the time of manufacture to link interfaces to a corresponding vehicle service. Such a configuration essentially results in a “hard coding” of vehicle services to vehicle interfaces. As an example, if a user presses a button for “next radio station” in their vehicle, the module responsible for controlling the changing of radio stations may be already hard-coded by the automobile manufacturer. This hard coding may limit flexibility; for example, any other applications designed to alter the radio station (e.g., radio controls on a steering wheel, radio controls within an infotainment system, radio controls via dedicated buttons on a center console, etc.) must also adhere rigidly to the predefined communication paths and interfaces. Furthermore, the same manufacturer may utilize a different radio, different radio control module, and/or different radio user controls and interfaces for different trim levels of the same base vehicle, necessitating the manufacturer to separately pre-configure a hard-coded communications path between the different components. The problem of fragmentation may be even more complex and difficult to manage when considering different vehicle models, different model years, different suppliers that may have inconsistent communication settings, different OEM manufacturers, etc.

Therefore, host OS 214 may provide a solution to the limitations of static interface management and the challenges of integrating SDV services and external services, as VHAL proxy 205 may provide a mapping between implementation-specific components and interfaceable reusable business logic components for SDV services, provide a mapping between interfaceable components of SDV services and external services, and provide bidirectional communication between interfaceable components of SDV services and external services. VHAL proxy 205 may facilitate dynamic interface discovery and utilization, in which implementations defined by one developer can be standardized, dynamically discovered, and integrated by other developers at runtime. For example, service bundle 220B may implement standardized unit type 216 declared by service bundle 220A, or by another service bundle (e.g., an external service bundle) at runtime, and/or service bundle 220A may be loaded and/or updated with an implementation of standardized unit type 216 by service bundle 220B or another service bundle (e.g., an external service bundle) at runtime. In other words, service bundles and/or service units may be dynamically updated with different implementations by other service bundles and/or service units defined across multiple trusted independent systems, multiple implementations of the same unit type may exist across multiple different service bundles across multiple trusted independent systems, and the multiple different service bundles may be dynamically updated independently of each other. In this way, flexibility in interface configurations may be improved, thus improving the adaptability and updatability of host OS 214 and component logic across vehicle computing system 200.

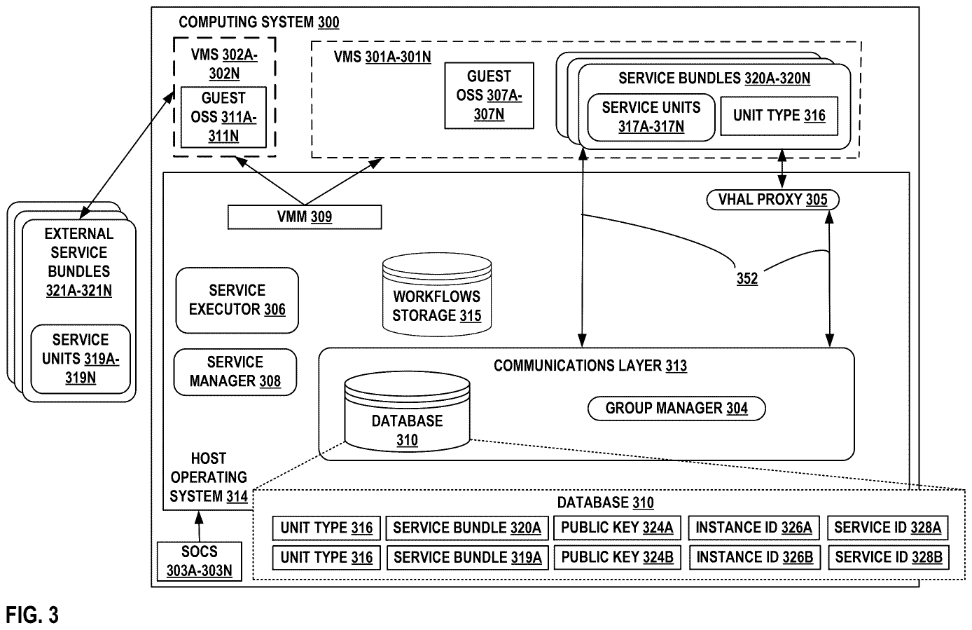

FIG. 3 illustrates another example computing system including an operating system that executes a plurality of trusted independent systems, in accordance with one or more techniques of this disclosure. As shown in FIG. 3, the example computing system includes vehicle computing system 300. For the purposes of clarity, one or more components of vehicle computing system 300 are described below as an example of vehicle computing system 100 as illustrated in FIG. 1 and/or vehicle computing system 200 as illustrated in FIG. 2. Vehicle computing system 300 may be included within an SDV and provide one or more types of functionalities for the SDV. FIG. 3 illustrates only one example of vehicle computing system 300, and many other examples of vehicle computing system 300 may be used in other instances and may include a subset of the components included in example vehicle computing system 300 or may include additional components not shown in FIG. 3.

In the example of FIG. 3, host OS 314, SOCs 303A-303N, VMM 309, VMs 301A-301N, guest OSs 307A-307N, service bundles 320A-320N, service units 317A-317N, unit type 316, VMs 302A-302N, guest OSs 311A-311N, external service bundles 321A-321N, service units 319A-319N, workflows storage 315, VHAL proxy 305, communications layer 313, database 310, group manager 304, and communication channels 352 may be similar if not substantially similar to host OS 114, SOCs 103A-103N, VMM 109, VMs 101A-101N, guest OSs 107A-107N, service bundles 120A-120N, service units 117A-117N, unit type 116, VMs 102A-102N, guest OSs 111A-111N, external service bundles 121A-121N, service units 119A-119N, workflows storage 115, VHAL proxy 105, communications layer 113, database 110, group manager 104, and communication channels 152 of FIG. 1, respectively. As shown in the example of FIG. 3, host OS 314 may further include service executor 306 and service manager 308.

In the example of FIG. 3, host OS 314 may manage service manager 308. Service manager 308 may be considered a module for a “lifecycle manager” process, or a module that manages lifecycle events for instances of service bundles 320 and/or service bundles 321. For example, service manager 308 may be part of a lifecycle manager or service orchestrator and may manage key stages or transitions that an instance of a service bundle undergoes, such as creation, activation or initialization, execution, scaling, updating, deactivation, reactivation, termination, and retirement. In general, service manager 308 may ensure that an instance of a service bundle is properly managed, maintained, and eventually retired in a controlled manner. In some examples, service manager 308 may initiate the initialization of service bundles 320 within VMs 301 by interacting with VMM 309 and guest OSs 307. That is, in examples in which service bundles 320 are executed on guest OSs 307, service manager 308 on host OS 314 may launch VMs 301, manage resources (e.g., allocate CPU, memory, or network(s) for VMs 301), manage the creation or initialization, suspension, migration, or termination of VMs 301, and manage service discovery and registration (e.g., service manager 308 may register services running in VMs 301). In examples in which computing system 300 connects with external service bundles 321, service manager 308 on host OS 314 may launch VMs 302 that connect to external service bundles 321, manage resources (e.g., allocate CPU, memory, or network(s) for VMs 302), manage the creation or initialization, suspension, migration, or termination of VMs 302, and manage service discovery and registration (e.g., service manager 308 may register services running in or connected to VMs 302).

Host OS 314 may also manage service executor 306. Service executor 306 may be in communication with service manager 308 and may initiate the execution of service bundles 320 within VMs 301 by interacting with VMM 309 and guest OSs 307. That is, in examples in which service bundles 320 are executed on guest OSs 307, service executor 306 on host OS 314 may initiate execution of service bundles 320 within VMs 301, and monitor the execution of service bundles 320 within VMs 301. In some examples, however, service bundles 320 may be initialized and executed on host OS 314.

In general, while service manager 308 may manage the lifecycle of an instance of a service bundle, service executor 306 may manage the execution of an instance of a service bundle (and any service units included therein) to provide one or more services. For example, service executor 306 may handle runtime operations and ensure that services are started, executed, and completed according to instructions from service manager 308. Service executor 306 may interface with service manager 308 via one or more communication channels 152, e.g., via APIs or message passing (e.g., using a message bus or middleware).

In general, each VM from VMs 101 may provide an execution environment for one or more processes such as an OS kernel of a guest OS from guests OSs 307A-307N and one or more service bundles from service bundles 320. Each VM from VMs 102 may provide an execution environment for one or more processes such as an OS kernel of a guest OS from guests OSs 311A-311N and one or more external service bundles from external service bundles 320.

In some examples, prior to executing service bundles within a VM from VMs 301 and/or external service bundles within a VM from VMs 302, host OS 314 may execute, using service manager 208, a binary program to initialize a network tap and packet filter system program within an OS kernel of a respective guest OS, in which the network tap and packet filter system program may monitor a respective lifecycle of one or more instances of service bundles and/or external service bundles that are executed within a respective VM. Then, host OS 314 may initialize, using service manager 308 and packet filter system program, the one or more instances of the one or more service bundles. More specifically, in some examples, initializing the one or more instances of the one or more service bundles may involve creating and storing process identities and service identities for the instances of the service bundles.

For example, in the example of FIG. 3, host OS 314 (and/or guest OS 307A) may initialize an instance of service bundle 320A. Service manager 308 may create a unique service identifier, such as unique service ID 328A, for the instance of service bundle 320A, which may be stored in a registry, such as database 310. In some examples, the unique service identifier may be a 64-bit identifier issued across computing system 300 and may be verifiable by communications layer 313. To initialize the instance of service bundle 310A, host OS 314 (and/or guest OS 307A) may obtain, from database 310, and based on unique service ID 328A, a respective service name associated with each of the one or more instances of the one or more service bundles, such as “service bundle 320A.” Then, host OS 314 (and/or guest OS 307A) may create, using the network tap and packet filter system program, a respective public-private key pair for each of the one or more instances of the one or more service bundles. For instance, the instance of service bundle 320A may be assigned a public-private key pair including public key 324A. In some examples, the private key may remain secure within a service executor process managed by service executor 306. That is, the private key for an instance of a service bundle may not be exposed outside of the service executor process managed by service executor 306. The private key may be used for verification, decrypting incoming messages, and/or signing outgoing data.

Host OS 314 (and/or guest OS 307A) may create, using the network tap and packet filter system program, a respective service identity object for each of the one or more instances of the one or more service bundles, in which the respective service identity object includes a respective unique process identifier, the respective service name, and a public key from the respective public-private key pair. For example, the service identity object for the instance of service bundle 320A may include a unique process identifier such as instance ID 326A, the service name such as “service bundle 320A”, and public key 324A. Host OS 314 (and/or guest OS 307A) may store, using the network tap and packet filter system program, each respective service identity object in a kernel map managed by the network tap and packet filter system program.

Host OS 314 (and/or a guest OS) may initialize a VM from VMs 301 and/or VM from VMs 302, in which the VM provides an execution environment for the guest OS kernel and the one or more instances of the one or more service bundles. For example, host OS 314 (and/or guest OS 307A) may initialize VM 301A, in which VM 301A provides an execution environment for the kernel of guest OS 307A and one or more instances of service bundle 320A and one or more instances of service bundle 320B. Host OS 314 (and/or guest OS 307A) may determine, based on an access control list, at least a first instance of service bundle 320A and at least a first instance of service bundle 320B that communicate with each other. In some examples, the instances of the service bundles that communicate with each other may or may not be executed within the same trusted independent system, e.g., VM. In some examples, the access control list may be embedded in the kernel map managed by the network tap and packet filter system program. Host OS 314 (and/or guest OS 307A) may fetch the service identity object for the first instance of service bundle 320A and the service identity object for the first instance of service bundle 320B. Host OS 314 (and/or guest OS 307A) may map the service identity object for the first instance of service bundle 320A to the service identity object for the first instance of service bundle 320B.

As such, while initializing the first instance of service bundle 320A and the first instance of service bundle 320B, host OS 314 (and/or guest OS 307A) may establish, based on the mapping, communication between the first instance of service bundle 320A and the first instance of service bundle 320B. Host OS 314 (and/or guest OS 307A) may then execute the first instance of service bundle 320A and the first instance of service bundle 320B.

In some examples, responsive to terminating the first instance of service bundle 320A, host OS 314 (and/or guest OS 307A) may delete the service identity object for the first instance of service bundle 320A in the kernel map managed by the network tap and packet filter system program. In some examples, responsive to deleting the service identity object for the first instance of service bundle 320A in the kernel map, host OS 314 (and/or guest OS 307A) may send a notification for the first instance of service bundle 320B, in which the notification indicates the termination of the first instance of service bundle 320A. In some examples, host OS 314 (and/or guest OS 307A or guest OS 307B) may terminate, based on the notification, the first instance of service bundle 320B.

As such, in general, a service identity object may be created for each instance of a service bundle before any application code or binary is loaded, and the service identity object may be used to map instances to each other, thus better ensuring secure communication, authentication, and data protection across the SDV system. Further, the public key included in the service identity object may be visible to other systems and/or service bundles, and may be used for encryption and/or verification of data sent to and from an instance of a service bundle. By using service identity objects as the root for all communication across the SDV system, the SDV system may dynamically handle secure communication, data integrity, and authentication needs during operations without the threat of a security breach.

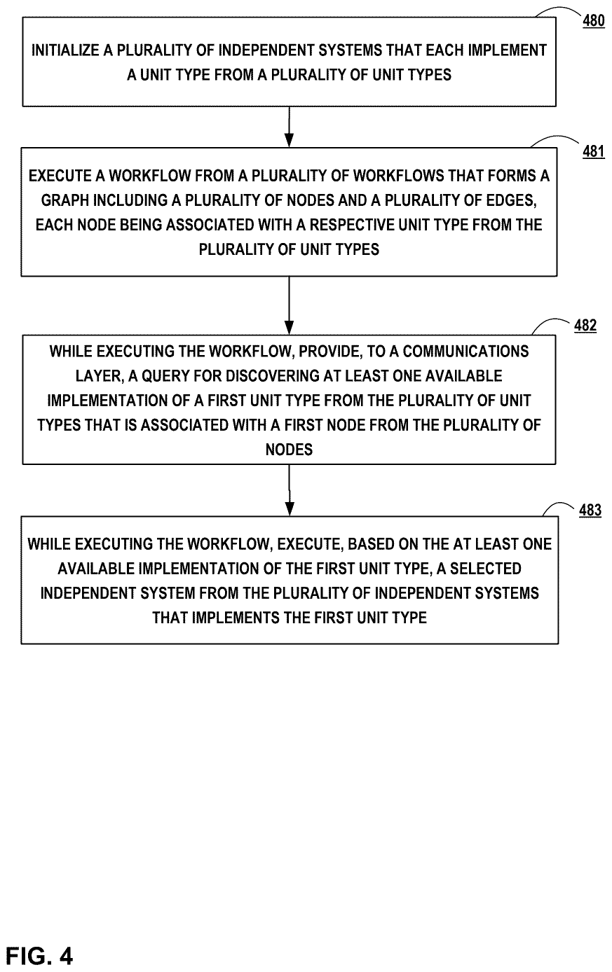

FIG. 4 is a flow chart illustrating example operations of an operating system that executes a plurality of independent systems, in accordance with one or more techniques of this disclosure. Computing system 100 initializes a plurality of independent systems, such as one or more VMs from VMs 101 and VMs 102, in which each independent system from the plurality of independent systems implements a unit type from a plurality of unit types (480). Computing system 100 executes a workflow from workflows storage 115, in which the workflow forms a graph that includes a plurality of nodes, and each node from the plurality of nodes is associated with a respective unit type from the plurality of unit types (481). While executing the workflow, computing system 100 provides, to communications layer 113, and based on unit type 116 from the plurality of unit types that is associated with a first node from the plurality of nodes, a query, in which the query includes a request to discover at least one available implementation of unit type 116 (482). While executing the workflow, computing system 100 executes, based on the at least one available implementation of unit type 116, a selected VM 101A from the plurality of independent systems, in which VM 101A implements unit type 116 (483).

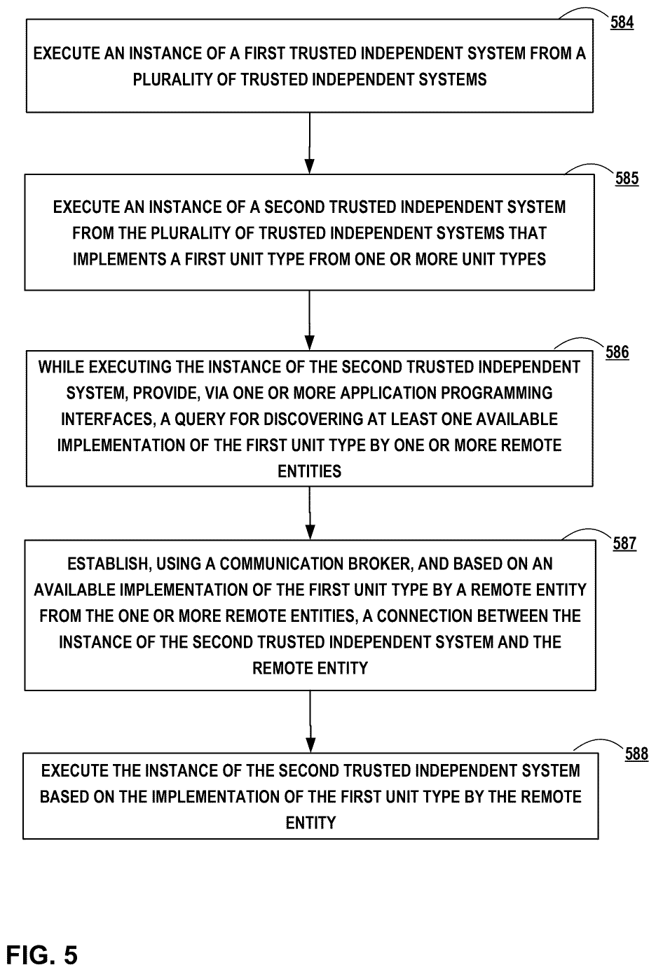

FIG. 5 is a flow chart illustrating example operations of an operating system that executes a plurality of independent systems, in accordance with one or more techniques of this disclosure. Computing system 100 executes an instance of trusted VM 102A from a plurality of trusted independent systems, in which the instance of VM 102A includes a communication broker, wherein the communication broker manages communication between the operating system and one or more remote entities, such as one or more external systems that host external service bundles 121, and the instance of VM 102A provides one or more application programming interfaces, in which one or more implementations of unit type 316 by the one or more remote entities may be discovered by the one or more application programming interfaces (584). Computing system 100 executes an instance of VM 101A from a plurality of trusted independent systems, in which the instance of VM 101A implements unit type 116 (585). While executing the instance of VM 101A, computing system 100 provides, via the one or more application programming interfaces, a query, in which the query includes a request to discover at least one available implementation of unit type 116 by the one or more remote entities, such as a remote entity that hosts service bundle 121A (586). Computing system 100 establishes, using the communication broker, and based on an available implementation of unit type 116 by a remote entity that hosts service bundle 121A, a connection between the instance of VM 101A and the remote entity (587). Computing system 100 executes the instance of VM 101A, and/or service bundle 120A, based on the implementation of unit type 116 by the remote entity (588).

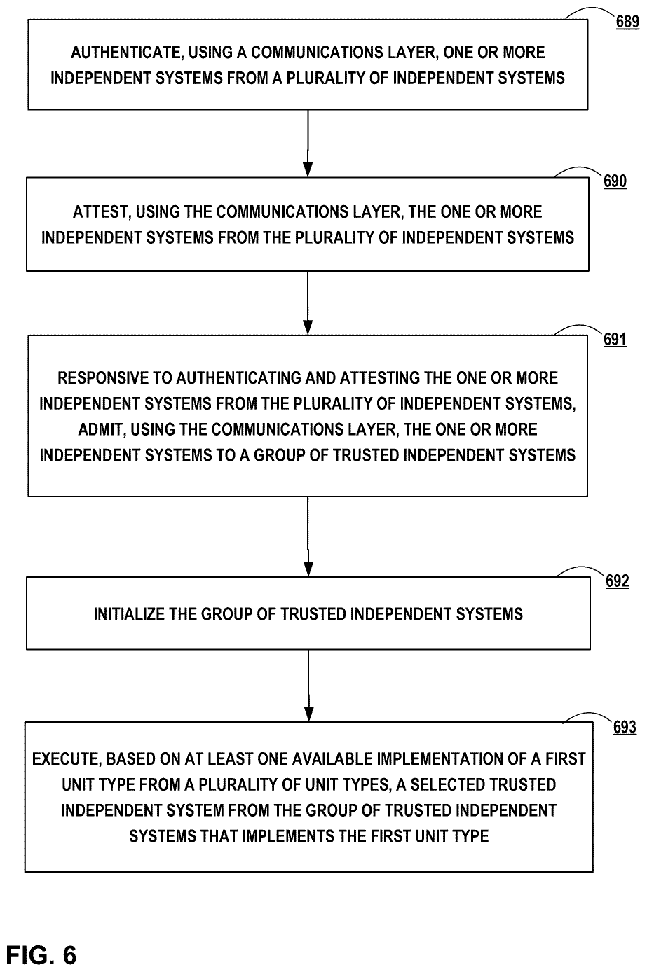

FIG. 6 is a flow chart illustrating example operations of an operating system that executes a plurality of independent systems, in accordance with one or more techniques of this disclosure. Computing system 100 authenticates, using communications layer 113, one or more independent systems from a plurality of independent systems, such as VMs 101 and VMs 102 (689). Computing system 100 attests, using communications layer 113, the one or more independent systems from the plurality of independent systems (690). Responsive to authenticating and attesting the one or more independent systems from the plurality of independent systems, computing system 100 admits, using communications layer 113 and group manager 104, the one or more independent systems to a group, in which the group is a plurality of trusted independent systems (691). Computing system 100 initializes the plurality of trusted independent systems, in which each trusted independent system from the plurality of trusted independent systems defines one or more service units and is a single source of truth for the one or more service units, and each of the one or more service units implements a unit type from a plurality of unit types (692). Computing system 100 executes, based on at least one available implementation of unit type 116, a selected trusted independent system from the plurality of trusted independent systems, such as VM 101A, in which VM 101A implements unit type 116 (693).

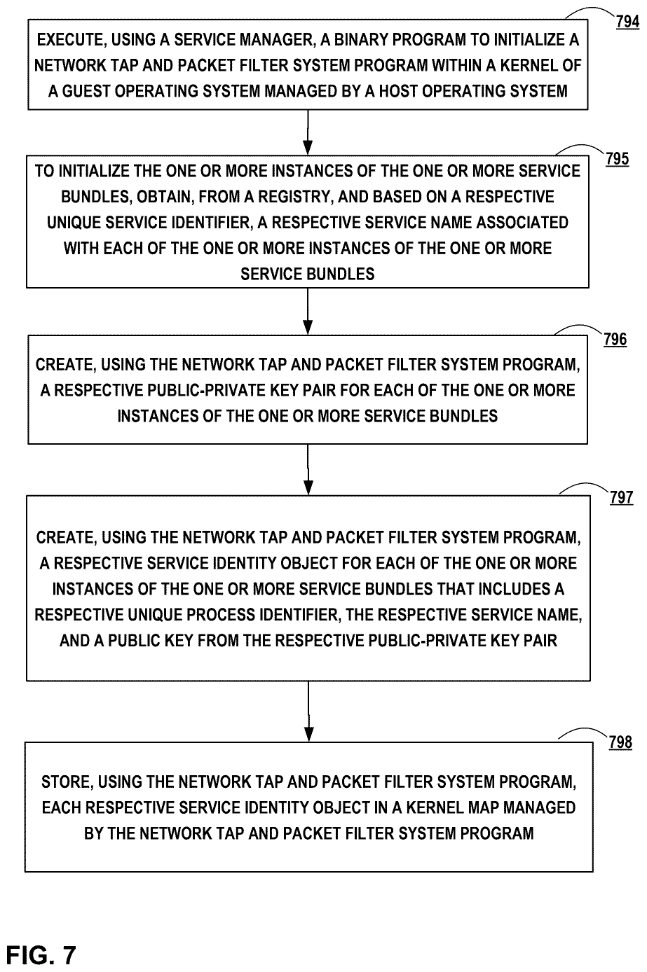

FIG. 7 is a flow chart illustrating example operations of an operating system that executes a plurality of independent systems, in accordance with one or more techniques of this disclosure. Computing system 100 executes, using service manager 308, a binary program to initialize a network tap and packet filter system program within a kernel of a guest operating system (e.g., one of guests OSs 307A-307N or guest OSs 311A-311N) managed by host OS 314, in which the network tap and packet filter system program monitors a respective lifecycle of one or more instances of one or more service bundles 320 (794). Computing system 100 initializes, using service manager 308, the one or more instances of the one or more service bundles 320. To initialize the one or more instances of the one or more service bundles 320, computing system 100 obtains, from a registry, e.g., database 310, and based on a respective unique service identifier, such as service ID 328A, a respective service name associated with each of the one or more instances of the one or more service bundles 320, such as instance ID 326A (795). To initialize the one or more instances of the one or more service bundles 320, computing system 100 further creates, using the network tap and packet filter system program, a respective public-private key pair for each of the one or more instances of the one or more service bundles 320 (796). To initialize the one or more instances of the one or more service bundles 320, computing system 100 further creates, using the network tap and packet filter system program, a respective service identity object for each of the one or more instances of the one or more service bundles 320, in which the respective service identity object includes a respective unique process identifier, the respective service name, and a public key from the respective public-private key pair (797). To initialize the one or more instances of the one or more service bundles 320, computing system 100 further stores, using the network tap and packet filter system program, each respective service identity object in a kernel map managed by the network tap and packet filter system program (798).

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

This disclosure includes the following examples:
Example 1: A method includes initializing, by an operating system of a vehicle, a plurality of independent systems, wherein each independent system from the plurality of independent systems implements a unit type from a plurality of unit types; executing, by the operating system, a workflow from a plurality of workflows, wherein the workflow forms a graph that includes a plurality of nodes, and wherein each node from the plurality of nodes is associated with a respective unit type from the plurality of unit types; while executing the workflow, providing, by the operating system, and to a communications layer, and based on a first unit type from the plurality of unit types, a query, wherein the first unit type is associated with a first node from the plurality of nodes, and wherein the query includes a request to discover at least one available implementation of the first unit type; and while executing the workflow, executing, by the operating system, and based on the at least one available implementation of the first unit type, a selected independent system from the plurality of independent systems, wherein the selected independent system implements the first unit type.
Example 2: The method of example 1, wherein providing the query further comprises: while executing the workflow, querying, by the operating system, and based on the query, a database managed by a communications layer to determine whether one or more independent systems from the plurality of independent systems that implement the first unit type are available; and responsive to determining one or more independent systems that implement the first unit type are available, selecting, by the operating system, the selected independent system from the one or more independent systems that implement the first unit type and are available.
Example 3: The method of example 2, wherein selecting the selected independent system is based on one or more resource permissions specified by the workflow.
Example 4: The method of any of examples 2 and 3, further includes responsive to determining no independent systems from the plurality of independent systems that implement the first unit type are available, pausing, by the operating system, the execution of the workflow.
Example 5: The method of any of examples 1 through 4, wherein the graph further includes a plurality of edges, and wherein each edge from the plurality of edges represents a dependency between at least two nodes.
Example 6: The method of any of examples 1 through 5, wherein the graph is a directed acyclic graph.
Example 7: The method of any of examples 1 through 6, wherein the vehicle is a software defined vehicle.
Example 8: A computing system includes one or more processors; and one or more storage devices that store instructions, wherein the instructions, when executed by the one or more processors, cause the one or more processors to: initialize a plurality of independent systems, wherein each independent system from the plurality of independent systems implements a unit type from a plurality of unit types; execute a workflow from a plurality of workflows, wherein the workflow forms a graph that includes a plurality of nodes, and wherein each node from the plurality of nodes is associated with a respective unit type from the plurality of unit types; while executing the workflow, provide, to a communications layer, and based on a first unit type from the plurality of unit types, a query, wherein the first unit type is associated with a first node from the plurality of nodes, and wherein the query includes a request to discover at least one available implementation of the first unit type; and while executing the workflow, execute, based on the at least one available implementation of the first unit type, a selected independent system from the plurality of independent systems, wherein the selected independent system implements the first unit type.
Example 9: The computing system of example 8, wherein to provide the query, the instructions further cause the one or more processors to: while executing the workflow, query, based on the query, a database managed by a communications layer to determine whether one or more independent systems from the plurality of independent systems that implement the first unit type are available; and responsive to determining one or more independent systems that implement the first unit type are available, select the selected independent system from the one or more independent systems that implement the first unit type and are available.
Example 10: The computing system of example 9, wherein selecting the selected independent system is based on one or more resource permissions specified by the workflow.
Example 11: The computing system of any of examples 9 and 10, wherein the instructions further cause the one or more processors to: responsive to determining no independent systems from the plurality of independent systems that implement the first unit type are available, pause the execution of the workflow.
Example 12: The computing system of any of examples 8 through 11, wherein the graph further includes a plurality of edges, and wherein each edge from the plurality of edges represents a dependency between at least two nodes.
Example 13: The computing system of any of examples 8 through 12, wherein the graph is a directed acyclic graph.
Example 14: The computing system of any of examples 8 through 13, wherein the vehicle is a software defined vehicle.
Example 15: A non-transitory computer-readable storage medium encoded with instructions that, when executed by one or more processors, cause the one or more processors to: initialize a plurality of independent systems, wherein each independent system from the plurality of independent systems implements a unit type from a plurality of unit types; execute a workflow from a plurality of workflows, wherein the workflow forms a graph that includes a plurality of nodes, and wherein each node from the plurality of nodes is associated with a respective unit type from the plurality of unit types; while executing the workflow, provide, to a communications layer, and based on a first unit type from the plurality of unit types, a query, wherein the first unit type is associated with a first node from the plurality of nodes, and wherein the query includes a request to discover at least one available implementation of the first unit type; and while executing the workflow, execute, based on the at least one available implementation of the first unit type, a selected independent system from the plurality of independent systems, wherein the selected independent system implements the first unit type.
Example 16: The non-transitory computer-readable storage medium of example 15, wherein to provide the query, the instructions further cause the one or more processors to: while executing the workflow, query, based on the query, a database managed by a communications layer to determine whether one or more independent systems from the plurality of independent systems that implement the first unit type are available; and responsive to determining one or more independent systems that implement the first unit type are available, select the selected independent system from the one or more independent systems that implement the first unit type and are available.
Example 17: The non-transitory computer-readable storage medium of example 16, wherein selecting the selected independent system is based on one or more resource permissions specified by the workflow.
Example 18: The non-transitory computer-readable storage medium of any of examples 16 and 17, wherein the instructions further cause the one or more processors to: responsive to determining no independent systems from the plurality of independent systems that implement the first unit type are available, pause the execution of the workflow.
Example 19: The non-transitory computer-readable storage medium of any of examples 15 through 18, wherein the graph further includes a plurality of edges, wherein the graph is a directed acyclic graph, and wherein each edge from the plurality of edges represents a dependency between at least two nodes.
Example 20: The non-transitory computer-readable storage medium of any of examples 15 through 19, wherein the vehicle is a software defined vehicle.
Example 22: The method of example 21, wherein the first trusted independent system is a virtual machine.
Example 23: The method of example 21, wherein the first trusted independent system is an in-vehicle infotainment system, wherein the connection is a network connection, and wherein the remote entity is an application installed on a computing device.
Example 24: The method of any of examples 21 and 22, wherein the connection is a Transport Layer Security connection, and wherein the remote entity is a cloud computing system.
Example 25: The method of any of examples 21 through 23, wherein the connection is a User Datagram Protocol connection, and wherein the remote entity is an automotive open system architecture component.
Example 26: The method of any of examples 21 through 24, wherein the instance of the first trusted independent system is a first instance of the first trusted independent system, wherein the communication broker is a first communication broker, wherein the instance of the second trusted independent system is a first instance of the second trusted independent system, wherein the remote entity is a first remote entity, the method further includes executing, by the operating system, a second instance of the first trusted independent system, wherein the second instance of the first trusted independent system includes a second communication broker, wherein the second communication broker manages communication between the operating system and the one or more remote entities, and wherein the second instance of the first trusted independent system provides the one or more application programming interfaces; executing, by the operating system, a second instance of the second trusted independent, wherein the second instance of the second trusted independent system implements the first unit type from the one or more unit types; while executing the second instance of the second trusted independent system, providing, by the operating system, and via the one or more application programming interfaces, a query, wherein the query includes a request to discover at least one available implementation of the first unit type by the one or more remote entities; establishing, by the operating system, and using the second communication broker, and based on an available implementation of the first unit type by a second remote entity from the one or more remote entities, a connection between the second instance of the second trusted independent system and the second remote entity; and executing, by the operating system, the second instance of the second trusted independent system based on the implementation of the first unit type by the second remote entity.
Example 27: The method of example 26, wherein the first instance of the second trusted independent system and the second instance of the second trusted independent system are executed simultaneously.
Example 28: The method of any of examples 21 through 26, wherein the vehicle is a software defined vehicle.
Example 29: A computing system includes one or more processors; and one or more storage devices that store instructions, wherein the instructions, when executed by the one or more processors, cause the one or more processors to: execute an instance of a first trusted independent system from a plurality of trusted independent systems, wherein the instance of the first trusted independent system includes a communication broker, wherein the communication broker manages communication between the operating system and one or more remote entities, wherein the instance of the first trusted independent system provides one or more application programming interfaces, and wherein one or more implementations of one or more unit types by the one or more remote entities are discovered via the one or more; execute an instance of a second trusted independent system from a plurality of trusted independent systems, wherein the instance of the second trusted independent system implements a first unit type from the one or more unit types; while executing the instance of the second trusted independent system, provide, via the one or more application programming interfaces, a query, wherein the query includes a request to discover at least one available implementation of the first unit type by the one or more remote entities; establish, using the communication broker, and based on an available implementation of the first unit type by a remote entity from the one or more remote entities, a connection between the instance of the second trusted independent system and the remote entity; and execute the instance of the second trusted independent system based on the implementation of the first unit type by the remote entity.
Example 30: The computing system of example 29, wherein the first trusted independent system is a virtual machine.
Example 31: The computing system of example 29, wherein the first trusted independent system is an in-vehicle infotainment system, wherein the connection is a network connection, and wherein the remote entity is an application installed on a computing device.
Example 32: The computing system of any of examples 29 and 30, wherein the connection is a Transport Layer Security connection, and wherein the remote entity is a cloud computing system.
Example 33: The computing system of any of examples 29 through 31, wherein the connection is a User Datagram Protocol connection, and wherein the remote entity is an automotive open system architecture component.
Example 34: The computing system of any of examples 29 through 32, wherein the instance of the first trusted independent system is a first instance of the first trusted independent system, wherein the communication broker is a first communication broker, wherein the instance of the second trusted independent system is a first instance of the second trusted independent system, wherein the remote entity is a first remote entity, and wherein the instructions further cause the one or more processors to: execute a second instance of the first trusted independent system, wherein the second instance of the first trusted independent system includes a second communication broker, wherein the second communication broker manages communication between the operating system and the one or more remote entities, and wherein the second instance of the first trusted independent system provides the one or more application programming interfaces; execute a second instance of the second trusted independent, wherein the second instance of the second trusted independent system implements the first unit type from the one or more unit types; while executing the second instance of the second trusted independent system, provide, via the one or more application programming interfaces, a query, wherein the query includes a request to discover at least one available implementation of the first unit type by the one or more remote entities; establish, using the second communication broker, and based on an available implementation of the first unit type by a second remote entity from the one or more remote entities, a connection between the second instance of the second trusted independent system and the second remote entity; and execute the second instance of the second trusted independent system based on the implementation of the first unit type by the second remote entity.
Example 35: The computing system of example 34, wherein the first instance of the second trusted independent system and the second instance of the second trusted independent system are executed simultaneously.
Example 36: The computing system of any of examples 29 through 34, wherein the vehicle is a software defined vehicle.
Example 37: A non-transitory computer-readable storage medium encoded with instructions that, when executed by one or more processors, cause the one or more processors to: execute an instance of a first trusted independent system from a plurality of trusted independent systems, wherein the instance of the first trusted independent system includes a communication broker, wherein the communication broker manages communication between the operating system and one or more remote entities, wherein the instance of the first trusted independent system provides one or more application programming interfaces, and wherein one or more implementations of one or more unit types by the one or more remote entities are discovered via the one or more; execute an instance of a second trusted independent system from a plurality of trusted independent systems, wherein the instance of the second trusted independent system implements a first unit type from the one or more unit types; while executing the instance of the second trusted independent system, provide, via the one or more application programming interfaces, a query, wherein the query includes a request to discover at least one available implementation of the first unit type by the one or more remote entities; establish, using the communication broker, and based on an available implementation of the first unit type by a remote entity from the one or more remote entities, a connection between the instance of the second trusted independent system and the remote entity; and execute the instance of the second trusted independent system based on the implementation of the first unit type by the remote entity.
Example 38: The non-transitory computer-readable storage medium of example 37, wherein the first trusted independent system is a virtual machine.
Example 39: The non-transitory computer-readable storage medium of example 37, wherein the first trusted independent system is an in-vehicle infotainment system, wherein the connection is a network connection, and wherein the remote entity is an application installed on a computing device.
Example 40: The non-transitory computer-readable storage medium of any of examples 37 and 38, wherein the connection is a Transport Layer Security connection, and wherein the remote entity is a cloud computing system.
Example 41: The non-transitory computer-readable storage medium of any of examples 37 through 39, wherein the connection is a User Datagram Protocol connection, and wherein the remote entity is an automotive open system architecture component.
Example 42: The non-transitory computer-readable storage medium of any of examples 37 through 40, wherein the instance of the first trusted independent system is a first instance of the first trusted independent system, wherein the communication broker is a first communication broker, wherein the instance of the second trusted independent system is a first instance of the second trusted independent system, wherein the remote entity is a first remote entity, and wherein the instructions further cause the one or more processors to: execute a second instance of the first trusted independent system, wherein the second instance of the first trusted independent system includes a second communication broker, wherein the second communication broker manages communication between the operating system and the one or more remote entities, and wherein the second instance of the first trusted independent system provides the one or more application programming interfaces; execute a second instance of the second trusted independent, wherein the second instance of the second trusted independent system implements the first unit type from the one or more unit types; while executing the second instance of the second trusted independent system, provide, via the one or more application programming interfaces, a query, wherein the query includes a request to discover at least one available implementation of the first unit type by the one or more remote entities; establish, using the second communication broker, and based on an available implementation of the first unit type by a second remote entity from the one or more remote entities, a connection between the second instance of the second trusted independent system and the second remote entity; and execute the second instance of the second trusted independent system based on the implementation of the first unit type by the second remote entity.
Example 43: The non-transitory computer-readable storage medium of example 42, wherein the first instance of the second trusted independent system and the second instance of the second trusted independent system are executed simultaneously.
Example 44: The non-transitory computer-readable storage medium of any of examples 37 through 42, wherein the vehicle is a software defined vehicle.
Example 45: A method includes authenticating, by an operating system of a vehicle, and using a communications layer, one or more independent systems from a plurality of independent systems; attesting, by the operating system and using the communications layer, the one or more independent systems from the plurality of independent systems; responsive to authenticating and attesting the one or more independent systems from the plurality of independent systems, admitting, by the operating system and using the communications layer, the one or more independent systems to a group, wherein the group is a plurality of trusted independent systems; initializing, by the operating system, the plurality of trusted independent systems, wherein each trusted independent system from the plurality of trusted independent systems defines one or more service units and is a single source of truth for the one or more service units, and wherein each of the one or more service units implements a unit type from a plurality of unit types; and executing, by the operating system, and based on at least one available implementation of a first unit type from the plurality of unit types, a selected trusted independent system from the plurality of trusted independent systems, wherein the selected trusted independent system implements the first unit type.
Example 46: The method of example 45, wherein each trusted independent system from the plurality of trusted independent systems is a member of a leaderless group of trusted independent systems managed by the communications layer, and wherein the communications layer implements a group membership protocol.
Example 47: The method of example 46, wherein the leaderless group of trusted independent systems monitors a plurality of workflows.
Example 48: The method of example 46, wherein the leaderless group of trusted independent systems adheres to a shared state Byzantine agreement protocol, wherein communication within the leaderless group of trusted independent systems is based on a shared secret key.
Example 49: The method of any of examples 45 through 47, wherein the communications layer manages a database including entries of one or more service units for each unit type from the plurality of unit types, wherein each trusted independent system from the plurality of trusted independent systems is authorized to perform read operations on all entries, and wherein each trusted independent system is authorized to perform write operations on entries corresponding to the one or more service units for which the respective trusted independent system is the single source of truth.
Example 50: The method of example 49, wherein prior to executing the selected trusted independent system, the method comprises: querying, by the operating system, and based on the query, the database managed by the communications layer to determine whether one or more trusted independent systems from the plurality of trusted independent systems that implement the first unit type are available; and responsive to determining one or more trusted independent systems that implement the first unit type are available, selecting, by the operating system, the selected trusted independent system from the one or more trusted independent systems that implement the first unit type and are available.
Example 51: The method of any of examples 45 through 49, wherein the vehicle is a software defined vehicle.
Example 52: A computing system includes one or more processors; and one or more storage devices that store instructions, wherein the instructions, when executed by the one or more processors, cause the one or more processors to: authenticate, using a communications layer, one or more independent systems from a plurality of independent systems; attest, using the communications layer, the one or more independent systems from the plurality of independent systems; responsive to authenticating and attesting the one or more independent systems from the plurality of independent systems, admit, using the communications layer, the one or more independent systems to a group, wherein the group is a plurality of trusted independent systems; initialize the plurality of trusted independent systems, wherein each trusted independent system from the plurality of trusted independent systems defines one or more service units and is a single source of truth for the one or more service units, and wherein each of the one or more service units implements a unit type from a plurality of unit types; and execute, based on at least one available implementation of a first unit type from the plurality of unit types, a selected trusted independent system from the plurality of trusted independent systems, wherein the selected trusted independent system implements the first unit type.
Example 53: The computing system of example 52, wherein each trusted independent system from the plurality of trusted independent systems is a member of a leaderless group of trusted independent systems managed by the communications layer, and wherein the communications layer implements a group membership protocol.
Example 54: The computing system of example 53, wherein the leaderless group of trusted independent systems monitors a plurality of workflows.
Example 55: The computing system of example 53, wherein the leaderless group of trusted independent systems adheres to a shared state Byzantine agreement protocol, wherein communication within the leaderless group of trusted independent systems is based on a shared secret key.
Example 56: The computing system of any of examples 52 through 54, wherein the communications layer manages a database including entries of one or more service units for each unit type from the plurality of unit types, wherein each trusted independent system from the plurality of trusted independent systems is authorized to perform read operations on all entries, and wherein each trusted independent system is authorized to perform write operations on entries corresponding to the one or more service units for which the respective trusted independent system is the single source of truth.
Example 57: The computing system of example 56, wherein prior to executing the selected trusted independent system, the instructions further cause the one or more processors to: query, based on the query, the database managed by the communications layer to determine whether one or more trusted independent systems from the plurality of trusted independent systems that implement the first unit type are available; and responsive to determining one or more trusted independent systems that implement the first unit type are available, select the selected trusted independent system from the one or more trusted independent systems that implement the first unit type and are available.
Example 58: The computing system of any of examples 52 through 56, wherein the vehicle is a software defined vehicle.
Example 59: A non-transitory computer-readable storage medium encoded with instructions that, when executed by one or more processors, cause the one or more processors to: authenticate, using a communications layer, one or more independent systems from a plurality of independent systems; attest, using the communications layer, the one or more independent systems from the plurality of independent systems; responsive to authenticating and attesting the one or more independent systems from the plurality of independent systems, admit, using the communications layer, the one or more independent systems to a group, wherein the group is a plurality of trusted independent systems; initialize the plurality of trusted independent systems, wherein each trusted independent system from the plurality of trusted independent systems defines one or more service units and is a single source of truth for the one or more service units, and wherein each of the one or more service units implements a unit type from a plurality of unit types; and execute, based on at least one available implementation of a first unit type from the plurality of unit types, a selected trusted independent system from the plurality of trusted independent systems, wherein the selected trusted independent system implements the first unit type.
Example 60: The non-transitory computer-readable storage of example 59, wherein each trusted independent system from the plurality of trusted independent systems is a member of a leaderless group of trusted independent systems managed by the communications layer, and wherein the communications layer implements a group membership protocol.
Example 61: The non-transitory computer-readable storage of example 60, wherein the leaderless group of trusted independent systems monitors a plurality of workflows.
Example 62: The non-transitory computer-readable storage of example 60, wherein the leaderless group of trusted independent systems adheres to a shared state Byzantine agreement protocol, wherein communication within the leaderless group of trusted independent systems is based on a shared secret key.
Example 63: The non-transitory computer-readable storage of any of examples 59 through 61, wherein the communications layer manages a database including entries of one or more service units for each unit type from the plurality of unit types, wherein each trusted independent system from the plurality of trusted independent systems is authorized to perform read operations on all entries, and wherein each trusted independent system is authorized to perform write operations on entries corresponding to the one or more service units for which the respective trusted independent system is the single source of truth.
Example 64: The non-transitory computer-readable storage of example 63, wherein prior to executing the selected trusted independent system, the instructions further cause the one or more processors to: query, based on the query, the database managed by the communications layer to determine whether one or more trusted independent systems from the plurality of trusted independent systems that implement the first unit type are available; and responsive to determining one or more trusted independent systems that implement the first unit type are available, select the selected trusted independent system from the one or more trusted independent systems that implement the first unit type and are available.
Example 65: The non-transitory computer-readable storage of any of examples 59 through 63, wherein the vehicle is a software defined vehicle.
Example 66: A method includes executing, by an operating system of a vehicle, and using a service manager, a binary program to initialize a network tap and packet filter system program within a kernel of a guest operating system managed by the operating system, wherein the network tap and packet filter system program monitors a respective lifecycle of one or more instances of one or more service bundles; initializing, by the operating system, and using the service manager, the one or more instances of the one or more service bundles, wherein initializing the one or more instances of the one or more service bundles further comprises: obtaining, by the operating system and from a registry, and based on a respective unique service identifier, a respective service name associated with each of the one or more instances of the one or more service bundles; creating, by the operating system and using the network tap and packet filter system program, a respective public-private key pair for each of the one or more instances of the one or more service bundles; creating, by the operating system and using the network tap and packet filter system program, a respective service identity object for each of the one or more instances of the one or more service bundles, wherein the respective service identity object includes a respective unique process identifier, the respective service name, and a public key from the respective public-private key pair; and storing, by the operating system and using the network tap and packet filter system program, each respective service identity object in a kernel map managed by the network tap and packet filter system program.
Example 67: The method of example 66, further includes initializing, by the operating system, a trusted independent system from a plurality of trusted independent systems, wherein the trusted independent system provides an execution environment for the kernel and the one or more instances of the one or more service bundles; determining, by the operating system, and based on an access control list, at least a first instance of a first service bundle and at least a first instance of a second service bundle that communicate with each other; fetching, by the operating system, the service identity object for the first instance of the first service bundle and the service identity object for the first instance of the second service bundle; and mapping, by the operating system, the service identity object for the first instance of the first service bundle to the service identity object for the first instance of the second service bundle.
Example 68: The method of example 67, wherein the access control list is embedded in the kernel map managed by the network tap and packet filter system program.
Example 69: The method of example 67, further includes while initializing the first instance of the first service bundle and the first instance of the second service bundle, establishing, by the operating system, and based on the mapping, communication between the first instance of the first service bundle and the first instance of the second service bundle; and executing, by the operating system, the first instance of the first service bundle and the first instance of the second service bundle.
Example 70: The method of example 69, further includes responsive to terminating the first instance of the first service bundle, deleting, by the operating system, the service identity object for the first instance of the first service bundle in the kernel map managed by the network tap and packet filter system program; and responsive to deleting the service identity object for the first instance of the first service bundle in the kernel map, sending, by the operating system, a notification for the first instance of the second service bundle, wherein the notification indicates the termination of the first instance of the first service bundle.
Example 71: The method of example 70, further includes terminating, by the operating system and based on the notification, the first instance of the second service bundle.
Example 72: The method of any of examples 66 through 70, wherein the vehicle is a software defined vehicle.
Example 73: A computing system includes one or more processors; and one or more storage devices that store instructions, wherein the instructions, when executed by the one or more processors, cause the one or more processors to: execute, using a service manager, a binary program to initialize a network tap and packet filter system program within a kernel of a guest operating system managed by the operating system, wherein the network tap and packet filter system program monitors a respective lifecycle of one or more instances of one or more service bundles; initialize, using the service manager, the one or more instances of the one or more service bundles, wherein to initialize the one or more instances of the one or more service bundles, the instructions further cause the one or more processors to: obtain, from a registry, and based on a respective unique service identifier, a respective service name associated with each of the one or more instances of the one or more service bundles; create, using the network tap and packet filter system program, a respective public-private key pair for each of the one or more instances of the one or more service bundles; create, using the network tap and packet filter system program, a respective service identity object for each of the one or more instances of the one or more service bundles, wherein the respective service identity object includes a respective unique process identifier, the respective service name, and a public key from the respective public-private key pair; and store, using the network tap and packet filter system program, each respective service identity object in a kernel map managed by the network tap and packet filter system program.
Example 74: The computing system of example 73, wherein the instructions further cause the one or more processors to: initialize a trusted independent system from a plurality of trusted independent systems, wherein the trusted independent system provides an execution environment for the kernel and the one or more instances of the one or more service bundles; determine, based on an access control list, at least a first instance of a first service bundle and at least a first instance of a second service bundle that communicate with each other; fetch the service identity object for the first instance of the first service bundle and the service identity object for the first instance of the second service bundle; and map the service identity object for the first instance of the first service bundle to the service identity object for the first instance of the second service bundle.
Example 75: The computing system of example 74, wherein the access control list is embedded in the kernel map managed by the network tap and packet filter system program.
Example 76: The computing system of example 74, wherein the instructions further cause the one or more processors to: while initializing the first instance of the first service bundle and the first instance of the second service bundle, establish, based on the mapping, communication between the first instance of the first service bundle and the first instance of the second service bundle; and execute the first instance of the first service bundle and the first instance of the second service bundle.
Example 77: The computing system of example 76, wherein the instructions further cause the one or more processors to: responsive to terminating the first instance of the first service bundle, delete the service identity object for the first instance of the first service bundle in the kernel map managed by the network tap and packet filter system program; and responsive to deleting the service identity object for the first instance of the first service bundle in the kernel map, send a notification for the first instance of the second service bundle, wherein the notification indicates the termination of the first instance of the first service bundle.
Example 78: The computing system of example 77, wherein the instructions further cause the one or more processors to: terminate, based on the notification, the first instance of the second service bundle.
Example 79: The computing system of any of examples 73 through 77, wherein the vehicle is a software defined vehicle.
Example 80: A non-transitory computer-readable storage medium encoded with instructions that, when executed by one or more processors, cause the one or more processors to: execute, using a service manager, a binary program to initialize a network tap and packet filter system program within a kernel of a guest operating system managed by the operating system, wherein the network tap and packet filter system program monitors a respective lifecycle of one or more instances of one or more service bundles; initialize, using the service manager, the one or more instances of the one or more service bundles, wherein to initialize the one or more instances of the one or more service bundles, the instructions further cause the one or more processors to: obtain, from a registry, and based on a respective unique service identifier, a respective service name associated with each of the one or more instances of the one or more service bundles; create, using the network tap and packet filter system program, a respective public-private key pair for each of the one or more instances of the one or more service bundles; create, using the network tap and packet filter system program, a respective service identity object for each of the one or more instances of the one or more service bundles, wherein the respective service identity object includes a respective unique process identifier, the respective service name, and a public key from the respective public-private key pair; and store, using the network tap and packet filter system program, each respective service identity object in a kernel map managed by the network tap and packet filter system program.
Example 81: The non-transitory computer-readable storage medium of example 80, wherein the instructions further cause the one or more processors to: initialize a trusted independent system from a plurality of trusted independent systems, wherein the trusted independent system provides an execution environment for the kernel and the one or more instances of the one or more service bundles; determine, based on an access control list, at least a first instance of a first service bundle and at least a first instance of a second service bundle that communicate with each other; fetch the service identity object for the first instance of the first service bundle and the service identity object for the first instance of the second service bundle; and map the service identity object for the first instance of the first service bundle to the service identity object for the first instance of the second service bundle.
Example 82: The non-transitory computer-readable storage medium of example 81, wherein the access control list is embedded in the kernel map managed by the network tap and packet filter system program.
Example 83: The non-transitory computer-readable storage medium of example 81, wherein the instructions further cause the one or more processors to: while initializing the first instance of the first service bundle and the first instance of the second service bundle, establish, based on the mapping, communication between the first instance of the first service bundle and the first instance of the second service bundle; and execute the first instance of the first service bundle and the first instance of the second service bundle.
Example 84: The non-transitory computer-readable storage medium of example 83, wherein the instructions further cause the one or more processors to: responsive to terminating the first instance of the first service bundle, delete the service identity object for the first instance of the first service bundle in the kernel map managed by the network tap and packet filter system program; and responsive to deleting the service identity object for the first instance of the first service bundle in the kernel map, send a notification for the first instance of the second service bundle, wherein the notification indicates the termination of the first instance of the first service bundle.
Example 85: The non-transitory computer-readable storage medium of example 84, wherein the instructions further cause the one or more processors to: terminate, based on the notification, the first instance of the second service bundle.
Example 86: The non-transitory computer-readable storage medium of any of examples 80 through 84, wherein the vehicle is a software defined vehicle.

What is claimed is:

1. A method comprising:
initializing, by an operating system of a vehicle, a plurality of independent systems, wherein each independent system from the plurality of independent systems implements a unit type from a plurality of unit types;
executing, by the operating system, a workflow from a plurality of workflows, wherein the workflow forms a graph that includes a plurality of nodes, and wherein each node from the plurality of nodes is associated with a respective unit type from the plurality of unit types;
while executing the workflow, providing, by the operating system, and to a communications layer, and based on a first unit type from the plurality of unit types, a query, wherein the first unit type is associated with a first node from the plurality of nodes, and wherein the query includes a request to discover at least one available implementation of the first unit type; and
while executing the workflow, executing, by the operating system, and based on the at least one available implementation of the first unit type, a selected independent system from the plurality of independent systems, wherein the selected independent system implements the first unit type.

2. The method of claim 1, wherein providing the query further comprises:
while executing the workflow, querying, by the operating system, and based on the query, a database managed by a communications layer to determine whether one or more independent systems from the plurality of independent systems that implement the first unit type are available; and
responsive to determining one or more independent systems that implement the first unit type are available, selecting, by the operating system, the selected independent system from the one or more independent systems that implement the first unit type and are available.

3. The method of claim 2, wherein selecting the selected independent system is based on one or more resource permissions specified by the workflow.

4. The method of claim 2, further comprising:
responsive to determining no independent systems from the plurality of independent systems that implement the first unit type are available, pausing, by the operating system, the execution of the workflow.

5. The method of claim 1, wherein the graph further includes a plurality of edges, and wherein each edge from the plurality of edges represents a dependency between at least two nodes.

6. The method of claim 1, wherein the graph is a directed acyclic graph.

7. The method of claim 1, wherein the vehicle is a software defined vehicle.

8. A method comprising:
executing, by an operating system of a vehicle, an instance of a first trusted independent system from a plurality of trusted independent systems, wherein the instance of the first trusted independent system includes a communication broker, wherein the communication broker manages communication between the operating system and one or more remote entities, wherein the instance of the first trusted independent system provides one or more application programming interfaces, and wherein one or more implementations of one or more unit types by the one or more remote entities are discovered via the one or more application programming interfaces;
executing, by the operating system, an instance of a second trusted independent system from a plurality of trusted independent systems, wherein the instance of the second trusted independent system implements a first unit type from the one or more unit types;
while executing the instance of the second trusted independent system, providing, by the operating system, and via the one or more application programming interfaces, a query, wherein the query includes a request to discover at least one available implementation of the first unit type by the one or more remote entities;
establishing, by the operating system, and using the communication broker, and based on an available implementation of the first unit type by a remote entity from the one or more remote entities, a connection between the instance of the second trusted independent system and the remote entity; and
executing, by the operating system, the instance of the second trusted independent system based on the implementation of the first unit type by the remote entity.

9. The method of claim 8, wherein the first trusted independent system is a virtual machine.

10. The method of claim 8, wherein the remote entity is an application installed on a computing device, a cloud computing system, an in-vehicle infotainment system, or an automotive open system architecture component.

11. The method of claim 8, wherein the instance of the first trusted independent system is a first instance of the first trusted independent system, wherein the communication broker is a first communication broker, wherein the instance of the second trusted independent system is a first instance of the second trusted independent system, wherein the remote entity is a first remote entity, the method further comprising:
executing, by the operating system, a second instance of the first trusted independent system, wherein the second instance of the first trusted independent system includes a second communication broker, wherein the second communication broker manages communication between the operating system and the one or more remote entities, and wherein the second instance of the first trusted independent system provides the one or more application programming interfaces;
executing, by the operating system, a second instance of the second trusted independent, wherein the second instance of the second trusted independent system implements the first unit type from the one or more unit types;
while executing the second instance of the second trusted independent system, providing, by the operating system, and via the one or more application programming interfaces, a query, wherein the query includes a request to discover at least one available implementation of the first unit type by the one or more remote entities;
establishing, by the operating system, and using the second communication broker, and based on an available implementation of the first unit type by a second remote entity from the one or more remote entities, a connection between the second instance of the second trusted independent system and the second remote entity; and
executing, by the operating system, the second instance of the second trusted independent system based on the implementation of the first unit type by the second remote entity, wherein the first instance of the second trusted independent system and the second instance of the second trusted independent system are executed simultaneously.

12. A method comprising:
authenticating, by an operating system of a vehicle, and using a communications layer, one or more independent systems from a plurality of independent systems;
attesting, by the operating system and using the communications layer, the one or more independent systems from the plurality of independent systems;
responsive to authenticating and attesting the one or more independent systems from the plurality of independent systems, admitting, by the operating system and using the communications layer, the one or more independent systems to a group, wherein the group is a plurality of trusted independent systems;
initializing, by the operating system, the plurality of trusted independent systems, wherein each trusted independent system from the plurality of trusted independent systems defines one or more service units and is a single source of truth for the one or more service units, and wherein each of the one or more service units implements a unit type from a plurality of unit types; and
executing, by the operating system, and based on at least one available implementation of a first unit type from the plurality of unit types, a selected trusted independent system from the plurality of trusted independent systems, wherein the selected trusted independent system implements the first unit type.

13. The method of claim 12, wherein each trusted independent system from the plurality of trusted independent systems is a member of a leaderless group of trusted independent systems managed by the communications layer, and wherein the communications layer implements a group membership protocol.

14. The method of claim 13, wherein the leaderless group of trusted independent systems adheres to a shared state Byzantine agreement protocol, wherein communication within the leaderless group of trusted independent systems is based on a shared secret key.

15. The method of claim 12, wherein the communications layer manages a database including entries of one or more service units for each unit type from the plurality of unit types, wherein each trusted independent system from the plurality of trusted independent systems is authorized to perform read operations on all entries, and wherein each trusted independent system is authorized to perform write operations on entries corresponding to the one or more service units for which the respective trusted independent system is the single source of truth.

16. A method comprising:
executing, by an operating system of a vehicle, and using a service manager, a binary program to initialize a network tap and packet filter system program within a kernel of a guest operating system managed by the operating system, wherein the network tap and packet filter system program monitors a respective lifecycle of one or more instances of one or more service bundles; and
initializing, by the operating system, and using the service manager, the one or more instances of the one or more service bundles, wherein initializing the one or more instances of the one or more service bundles further comprises:
obtaining, by the operating system and from a registry, and based on a respective unique service identifier, a respective service name associated with each of the one or more instances of the one or more service bundles;
creating, by the operating system and using the network tap and packet filter system program, a respective public-private key pair for each of the one or more instances of the one or more service bundles;
creating, by the operating system and using the network tap and packet filter system program, a respective service identity object for each of the one or more instances of the one or more service bundles, wherein the respective service identity object includes a respective unique process identifier, the respective service name, and a public key from the respective public-private key pair; and
storing, by the operating system and using the network tap and packet filter system program, each respective service identity object in a kernel map managed by the network tap and packet filter system program.

17. The method of claim 16, further comprising:
initializing, by the operating system, a trusted independent system from a plurality of trusted independent systems, wherein the trusted independent system provides an execution environment for the kernel and the one or more instances of the one or more service bundles;
determining, by the operating system, and based on an access control list, at least a first instance of a first service bundle and at least a first instance of a second service bundle that communicate with each other;
fetching, by the operating system, the service identity object for the first instance of the first service bundle and the service identity object for the first instance of the second service bundle; and
mapping, by the operating system, the service identity object for the first instance of the first service bundle to the service identity object for the first instance of the second service bundle.

18. The method of claim 17, wherein the access control list is embedded in the kernel map managed by the network tap and packet filter system program.

19. The method of claim 17, further comprising:
while initializing the first instance of the first service bundle and the first instance of the second service bundle, establishing, by the operating system, and based on the mapping, communication between the first instance of the first service bundle and the first instance of the second service bundle; and
executing, by the operating system, the first instance of the first service bundle and the first instance of the second service bundle.

20. The method of claim 17, further comprising:
responsive to terminating the first instance of the first service bundle, deleting, by the operating system, the service identity object for the first instance of the first service bundle in the kernel map managed by the network tap and packet filter system program;
responsive to deleting the service identity object for the first instance of the first service bundle in the kernel map, sending, by the operating system, a notification for the first instance of the second service bundle, wherein the notification indicates the termination of the first instance of the first service bundle; and
terminating, by the operating system and based on the notification, the first instance of the second service bundle.
